(19) United States
(12) Patent Application Publication
(10) Pub. No.: US 2014/0136412 A1
(43) Pub. Date: May 15, 2014

(54) LEAST COST ROUTING INTERCHANGE FOR B2B PURCHASE CARD PAYMENTS

(71) Applicant: Bora Payment Systems, LLC, Walnut Creek, CA (US)

(72) Inventor: Steven D. Evans, Hercules, CA (US)

(73) Assignee: BORA PAYMENT SYSTEMS, LLC, Walnut Creek, CA (US)

(21) Appl. No.: 14/156,362

(22) Filed: Jan. 15, 2014

Related U.S. Application Data
(63) Continuation of application No. 13/679,731, filed on Nov. 16, 2012.
(60) Provisional application No. 61/672,890, filed on Jul. 18, 2012.

(51) Int. Cl. G06Q 20/24; G06Q 20/40

(52) U.S. Cl. CPC G06Q 20/24; G06Q 20/40
USPC 705/44

(57) ABSTRACT

Methods and system for processing credit card payments, comprising receiving a credit card transaction, fabricating line item data to obtain favorable interchange rates for transactions, aggregating or disaggregating payments to obtain favorable interchange rates for transactions, and automatically deciding among various interchange rate options for transactions based on criteria chosen by the payer using these methods or system.

This application is a continuation application of U.S. patent application Ser. No. 13/679,731, Least Cost Routing Interchange for B2B Purchase Card Payments, by Evans, Attorney Docket No. BORA-01002US1, which claims priority from U.S. Provisional Application No. 61/672,890, filed on Jul. 18, 2012, both of which are incorporated herein by reference in its entirety.

### BACKGROUND OF THE INVENTION

Individuals and businesses can use various means of executing credit card payments to suppliers. For business-to-business (B2B) transactions, the supplier can often use card number information provided by the payer, perhaps collected from a previous payment, to authorize the payment. To process the payment, the supplier may use either a computer kiosk or software terminal, which may be provided by the merchant's bank or a reseller of IT services on behalf of the merchant bank, known hereinafter as an Acquiring Processor. The supplier provides the credit card number and invoice information required for completing the payment. The Acquiring Processor or merchant bank then passes this payment request data to the specified card network, such as Visa or MasterCard. The card network then settles the requested payment with the payer's bank or a reseller of IT services on behalf of the payer bank, known hereinafter as an Issuing Processor. The card network charges the supplier an interchange fee for using its services to process the transaction.

Interchange fee rates for B2B payment transactions vary based on several parameters. Card networks tend to vary the exact rates and conditions for the payments they process based on their own criteria. However, broad trends do generally describe industry practice regarding interchange rates. The Level 1 (L1) interchange rate is generally the highest and requires the least amount of information to be supplied along with the payment request. For L1, this is usually just the amount of money to be paid. The Level 2 (L2) interchange rate is generally lower than L1 but also requires sales tax data pertaining to the purchase. The Level 3 (L3) interchange rate is often even lower than L2 but requires more detailed data pertaining to the item purchased, such as quantity, SKU, and/or product description. The Large Ticket (LT) interchange rate is generally the lowest and requires similar data to that of L3 transactions, but is usually restricted to payments for one or more items costing at least several thousands of dollars.

While suppliers tend to favor lower interchange rates such as L2 and L3, they are often unable to obtain such rates for payment transactions. This may happen for a number of reasons. The Accounts Receivable personnel with the supplier are often not trained to add the requisite data to obtain the lower rates. The terminals provided by the Acquiring Processor or merchant bank may not admit such data even if the supplier had it. The Acquiring Processor platforms may not even be able to obtain rates such as L3.

Unlike the payment process described above, payments initiated by the payer or buyer instead of the supplier may be better suited to provide the requisite information for favorable interchange rates for the supplier. Here, the payer takes invoice information from the supplier, and, along with credit card data, uses a technology such as Bora's Payer Direct Hub (PDH) to communicate with the Acquiring Processor, which then proceeds as before and, upon confirmed authorization of payment, informs the supplier of successful payment. The issuing bank who carries the credit risk of the payer and who has issued the credit card to the payer (issuers have contracts with credit card networks such as Visa or MasterCard to use their networks for authorization and settlement and are subject to the interchange rates set by the card network(s) for whom they issue) may then reward the payer with a rebate to gain its favor. Often the amount of the rebate is related to the interchange rate. For example, a higher interchange rate generates more fees for the issuing bank, which usually results in a higher rebate for the payer. As such, payers may have an incentive to use a higher interchange rate.

### DESCRIPTION OF THE DRAWINGS

FIG. 1 depicts a block diagram illustrating one embodiment of a Payer Direct Hub (“PDH”).

FIG. 2 depicts an exemplary user interface for making payments using a PDH.

FIG. 3 depicts a block diagram illustrating an exemplary invoice payment component of the Payer Direct Hub shown in FIG. 1.

FIG. 4 depicts a block diagram illustrating an exemplary system for communication between a payer and the Payer Direct Hub via file transfer protocol.

FIG. 5 depicts an exemplary file into which the payer may enter payment data for communication to the PDH via file transfer protocol.

FIG. 6 depicts a flow chart describing one embodiment of a process for making payments.

FIG. 7 depicts a flow chart describing one embodiment of a process performed by the Payer Direct Hub to process payment request data, including interchange request information.

FIG. 8 depicts a flow chart describing one embodiment of a process performed by the Payer Direct Hub to automatically choose an interchange rate given a payer-supplied indication, and process the payment accordingly.

FIG. 9 depicts a flow chart describing one embodiment of a process performed by the Payer Direct Hub to generate payment requests at an L2 rate.

FIG. 10 depicts a flow chart describing one embodiment of a process performed by the Payer Direct Hub to generate payment requests at an L3 rate.

FIG. 11 depicts a flow chart describing one embodiment of a process performed by the Payer Direct Hub to generate payment requests at an LT rate.

FIG. 12 depicts a flow chart describing one embodiment of a process performed by the Payer Direct Hub to generate payment requests pursuant to an LR request.

FIG. 13 depicts a flow chart describing one embodiment of a process performed by the Payer Direct Hub to generate payment requests pursuant to an HR request.

FIG. 14 depicts a flow chart describing one embodiment of a process performed by the Payer Direct Hub to generate payment requests pursuant to a BRLR request.

FIG. 15 depicts a flow chart describing one embodiment of a process performed by the Payer Direct Hub to generate payment requests pursuant to an LCR request.

FIG. 16 depicts a block diagram describing one embodiment of a process performed by the Payer Direct Hub to transform payment request data by fabricating and adding information as appropriate to qualify for a suitable interchange rate.

FIG. 17 depicts a diagram describing an exemplary process by which the Payer Direct Hub parses payment request data from a user, decides whether or not to aggregate transactions, and passes payment requests onto an Acquiring Processor.

FIG. 18 depicts a diagram describing an exemplary process by which the Payer Direct Hub parses payment request data from a user, decides whether or not to disaggregate transactions, and passes payment requests onto an Acquiring Processor.

FIG. 19 depicts a flow chart describing one embodiment of a process by which the system may choose a credit card for payments based on payment data and interchange rate.

FIG. 20 depicts a diagram describing one embodiment of a system capable of performing the methods presently disclosed.

FIG. 21 is a block diagram depicting an exemplary process by which the Payer Direct Hub may aggregate multiple payments from multiple payers into a single payment destined for the same payee. FIG. 21A is a flow chart describing that process.

FIG. 22 depicts an exemplary payment reconciliation file for a payment aggregated from multiple payments from multiple payers, sent by the PDH to the payer to whom the payment is directed.

### DETAILED DESCRIPTION

One aspect of the disclosed technology is to enable a system to accept from payers data pertaining to the interchange rate applicable to a payment transaction along with standard information used in the payment request. The system may then evaluate the validity of some or all information provided about the request before passing it on to an Acquiring Processor or other relevant entity. In one embodiment, the system can, if applicable, fabricate and insert information for the purchase to obtain a better interchange rate. This information is added strictly for bookkeeping purposes, has no valuable content, and is not actually used by any parties, except by the Acquiring Processor to ‘qualify’ the transaction for L3 or LT rates, but not otherwise.

Another embodiment allows the system to decide which interchange rate and credit card information to supply for payment request data. This decision may be based on requirements provided by the payer alongside information pertaining to payments. For example, a payer may choose to make a Lowest Rate (LR) payment, whereby the system will submit payment request/s corresponding to the lowest interchange rate the supplier (as specified by the payment request) has previously accepted, assuming the payment otherwise qualifies for the rate. While a higher interchange rate for the supplier may entail a higher rebate for the payer, the payer may yet decide to have a payment routed at the lowest acceptable rate for the supplier in order to maintain positive relations with the supplier. But by paying at the lowest interchange rate previously accepted by the supplier, rather than at the lowest possible rate, the payer may then be receiving a higher rebate.

A further aspect of the disclosed technology includes the ability to use information provided by the payer, such as the supplier and payment date, in order to determine how to process and pass along the payment request. For example, if the payer requests a Large Ticket interchange rate, but no single item in the payment request costs enough to qualify for the LT rate for any of the user's credit cards, the system may aggregate multiple requests into one, provided they have a common supplier and payment date, and also provided that their added cost equals or exceeds that required to qualify for LT. The system may then add information as needed and instruct the target Acquirer Processor to treat the aggregate as a single payment transaction. Other embodiments may disaggregate payment requests into smaller or single payments if conducive to payer preferences. Note that for purposes of this document, credit cards include payment cards used for business to business transactions.

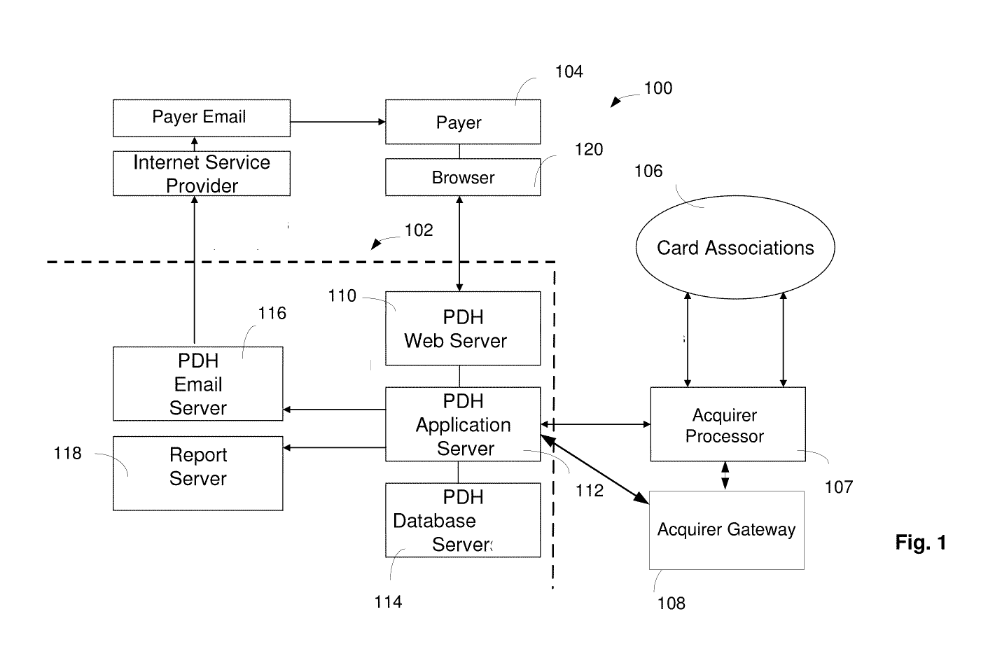

FIG. 1 illustrates a credit card payment system 100 as described in the previous paragraphs. The system 100 generally includes a Payer Direct Hub (PDH) 102, an Acquirer Processor 107, an Acquirer Gateway 108 and a Card Association network 106. As will be discussed in more detail later, the PDH 102 facilitates a method for processing credit card payments between the Payer 104 and multiple Payees. The PDH 102 allows the Payer 104 to schedule multiple credit card payments to multiple Payees for monies owed by the Payer through a single user interface.

PDH 102 communicates with either the Acquirer Processor 107 or the Acquirer Gateway 108. As used herein, an Acquirer refers to the acquiring bank in a credit card transaction. The acquiring bank is the Payee's merchant bank and typically has the liability associated with the merchant's (Payee) behavior in a transaction. Often the acquiring bank has a service contract with a service company to perform the acquiring function of routing credit card authorizations, settlements, and chargebacks for the acquiring bank on behalf of the Payee. This service company is referred to herein as the Acquirer Processor 107. The Acquirer Processor 107 shown in FIG. 1 is an intermediary or service bureau that provides a single point of access to various payment networks. For example, the Acquirer Processor 107 may provide access to card interchanges such as Visa, MasterCard, Discover, American Express, Diner's Card, and the like. The Acquirer Gateway 108 is an intermediary or service bureau that provides a single point of access to various Acquirer Processors 107. A few of the prominent vendors in this market include Cybersource, Pay-Me-Now and Authorize.net.

One embodiment of the PDH 102 is shown in FIG. 1. In this embodiment, the PDH 102 comprises a web server 110, an application server 112, a database server 114, an email server 116 and a report server 118. Each of these servers includes one or more processors in communication with memory, non-volatile storage and one or more communication interfaces (e.g., network interface, wireless interface, etc.).

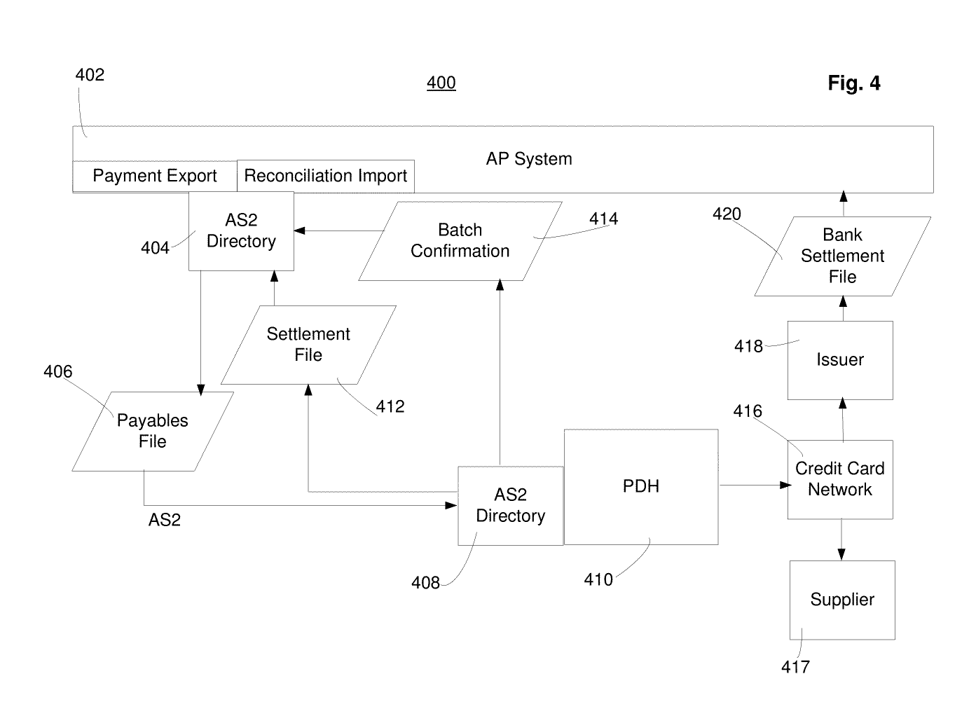

FIG. 1 illustrates that the Payer 104 accesses the PDH web server 110 through a browser 120. The web server 110, among other things, facilitates communication (e.g., SSL, HTTPS) between a Payer/Payee and their browsers and the application server 112 and provides the user interfaces (described below) that enables Payer and Payees to communicate with the PDH 102 via a standard web browser. In some embodiments, the Payer may not have to use a browser to login to the system by instead using file transfer protocols such as SFTP or AS2 to transfer files automatically to PDH 102, such that the PDH 102 automatically detects the arrival of the file and processes it accordingly. More detail regarding these embodiments is provided in FIG. 4.

The application server 112 performs many functions. By way of example only, the application server 112 provides data to the web server 110 for presentation to the Payers, adds data to, updates, and retrieves data from the database server 114, enforces the PDH business logic, communicates with an Acquirer Processor or Acquirer Gateway web servers via a secure channel (e.g., SSL/HTTPS) for the authorization and settlement of payment requests, and provides email requests to the email server 116 for the broadcasting of email alerts to Payers.

The database server 114 may, among other things, store Payer and Payee user information, credit card information (e.g., credit card number, statement end date, etc.), and information related to the payment requests, responds to data updates and data retrieval from the application server 112 and delivers data to report server 118 when requested. The email server 116 manages the transmission of email notifications generated by the Application Server 112 and sent to the Payer. The report server 118 generates reports that can be accessed by either a Payer or a Payee (described in more detail later).

Suppose the Payer is an employee of Company A and Company A issued the Payer a company commercial credit card (sometimes referred to as a payment card or purchase card). In one embodiment, the Payer 104 registers with the PDH 102 and obtains a unique Payer ID (company ID), a login ID (individual ID) and a password. To insure a second level of security, the Payer may install a digital certificate obtained from the PDH 102. The PDH 102 may also collect from the Payer 104 company and individual data such as a physical address and email address.

The Payer, after registering, may register a Payee by creating a Payee profile that includes, among other things, the Payee's Merchant ID (MID) and processing platform name. In some embodiments, the Payee may be registered by the Acquirer Processor. The Payee's processing platform may comprise either an Acquirer Processor 107 or an Acquirer Gateway 108. When a Payer adds sufficient information on a Payee (Merchant ID, processing platform, Payee address, etc.) necessary to route payment requests to the Payee, the Payee should be considered registered in the PDH 102 but not enrolled. A Payee is enrolled when at least one person (e.g., employee of Payee) is approved for the purposes of logging into the PDH 102 and accessing screens. In one embodiment, the Payee is assigned a Payee ID. Using the Payee ID, the Payee may access the PDH 102 and view only the reports and queues that the Payer has authorized the Payee to view (e.g., pending payments queues described in more detail later).

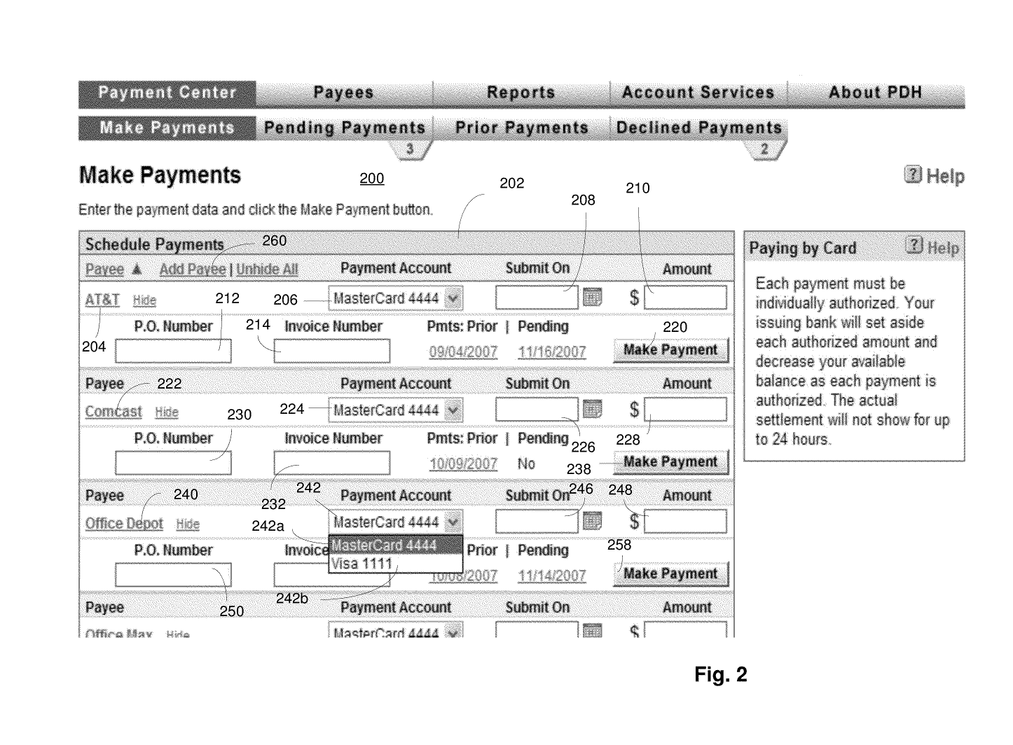

FIG. 2 illustrates an exemplary Make Payments user interface 200 that may be provided by the PDH 102 in order to allow the Payer to schedule payments to one or more Payees. The scheduled payments are for monies owed by the company that will be paid for by the employee on his issued commercial credit card. The Make Payments user interface 200 includes a screen 202 that allows the Payer 104 to schedule a credit card payment to one or more Payees. The Payer 104 schedules each payment request by designating, by way of example only, a payment account (commercial credit card to charge), a submit date (the date to charge the commercial credit card), a charge amount (the amount to charge the commercial credit card), a purchase order number, and an invoice number. For example, in FIG. 2, a Payer 104 is scheduling a payment request to pay for monies owed to three Payees: AT&T 204, Comcast 222 and Office Depot 240.

The Payer 104 schedules a payment request to AT&T 204 by entering in the payment data in screen 202. For example, the Payer 104 has selected to charge the money owed to AT&T 204 to the credit card designated as “MasterCard 4444” 206 in the drop-down menu. The credit card numbers available in the drop-down menu represents the commercial credit cards that the Payer is authorized to use. At a minimum, the Payer 104 also enters a date to charge “MasterCard 4444” in the Submit On window 208 and the amount to charge “MasterCard 4444” in the Amount window 210. If that is all the information the Payer 104 intends to include in the payment request to AT&T 204, the Payer may select the Make Payment button 220.

To aid in tracking the payment to AT&T 204, the Payer 104 may also enter a purchase order number in the P.O. Number window 212 and enter an invoice number in the Invoice Number window 214 before selecting the Make Payment button 220. This information is not required.

The Payer 104 may also schedule payment requests to Comcast 222 and Office Depot 240 before selecting a Make Payment button. To schedule a payment request to Comcast 222, the Payer 104 designates the payment account 224, the Submit On date 226 and the charge amount 228. The Payer 104 may also want to add a purchase order number in the P.O. Number window 230 and an invoice number in the Invoice Number window 232 for tracking purposes. After the payment request to Comcast 222 has been entered, the Payer 104 may select the Make Payment button 238.

To schedule a payment request to Office Depot 240, the Payer designates the Payment Account 242, the Submit On date 246 and the Amount 248. The Payment Account window 242 is shown as a drop-down menu containing two accounts: “MasterCard 4444” and “Visa 1111.” Such a drop-down menu limits the account choices provided to the Payer and prevents having to enter the entire account number every time a payment request is scheduled. To assist in tracking the payment to Office Depot 240, the Payer 104 may also enter the purchase order number in the P.O. Number window 250 and an invoice number in the Invoice Number window 252. After the payment information to Office Depot 240 has been entered, the Payer 104 may select the Make Payment button 258.

Upon selecting a Make Payment button, the PDH 102 generates payment requests based on the payment data entered for the specific Payee. For example, the PDH 102 generates a payment request based on the payment data to AT&T 204 when the Payer 104 selects the Make Payment button 220. The PDH 102 generates a payment request based on the payment data to Comcast 222 when the Payer 104 selects the Make Payment button 238, and so on. Each of the payment requests comprises a set of data required to process the payment to a Payee as a single credit card transaction. In the FIG. 2 embodiment, the PDH 102 will generate three separate payment requests: a payment request for AT&T 204, a payment request for Comcast 222, and a payment request for Office Depot 240. The PDH 102 stores each of the payment requests in a pending payment queue (to be discussed in more detail hereinafter).

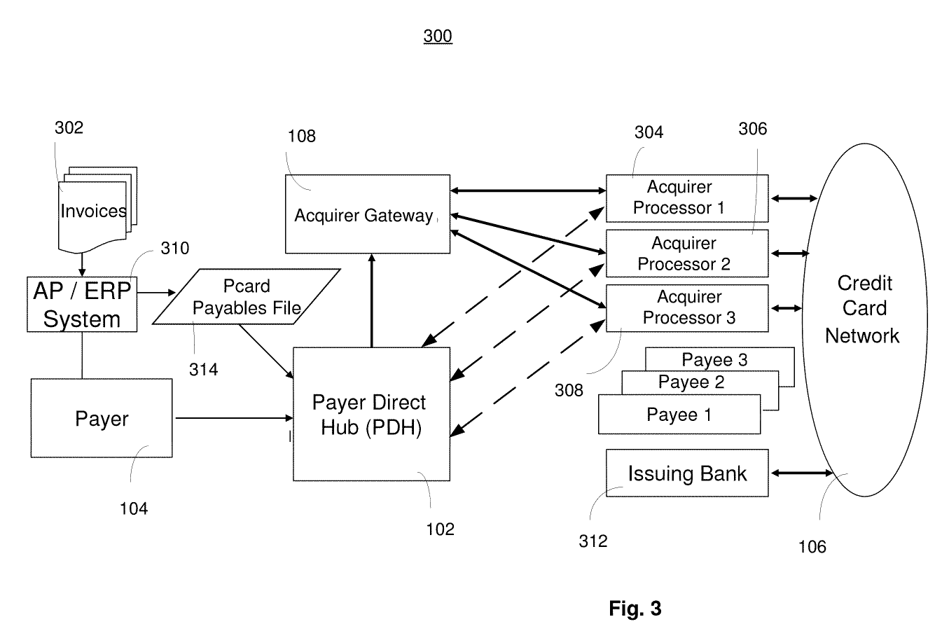

FIG. 3 illustrates a schematic diagram displaying one embodiment of the PDH 102 within a credit card processing system 300. For discussion purposes only, previously described elements will be labeled with the same reference numbers. The participants in the processing system 300 includes the PDH 102, the Payer 104, an Accounts Payable (AP) system 310, an Acquirer Gateway 108, Acquirer Processors 304-308, a credit card network 106 and an issuing bank 312. In some embodiments, batch files may be loaded (either manually or automatically via file transfer protocols such as SFTP or AS2), after which the payer may use the batch interface to instruct the system to approve the payments as a batch. In further embodiments, the batch file loads into PDH 102, and if the Payer has opted not to approve the payments, the system transfers these payments directly into a pending queue. However, in embodiments, the system processes these payments immediately if their respective payment dates are set to the current day. More detail is provided in FIG. 4.

Suppose, for example, that the Payer 104 is an employee of Company A, and Company A has issued the Payer a commercial credit card. In this example, suppose the Payer has purchased office supplies from Office Depot for Company A and Company A pays for a cellular phone it issued to the Payer. Depending on the arrangement between the Payer and Company A, the Payer or Company A (e.g., through its Accounts Payable department) may receive invoices 302 from Office Depot and AT&T. Thus, the term “Payer,” as used herein, may comprise the employee or Company A (e.g., Company A's accounts payable personnel, etc.). If it is the Payer's responsibility to schedule payments, the Payer 104 logs into the PDH 102 and schedules payment requests to Office Depot and AT&T in the Make Payments interface 200 as previously described above. Unlike a conventional credit card business model where the Payer would have to log onto the Office Depot website and the AT&T website individually and enter credit card information, a Payer, using the PDH 102, only logs onto a single website or user interface to schedule both of these payments.

The invoices 302 from each merchant (e.g., Office Depot and AT&T) may alternately be sent electronically (or otherwise) to Company A's Accounts Payable (AP) system 310. Company A's AP department 310 may receive invoices associated with purchases by Company A employees that have been issued a commercial card. The AP department 310 may enter or upload payment requests for monies owed by the Company to each merchant, creating a single payables file 314. The payables file 314 may then be sent electronically to the PDH 102. For example, suppose that Company A has fifteen employees (each referred to as a Payer). The AP system 310 may schedule payment requests (electronically or entered manually) for monies owed by Company A to merchants for charges accrued by its fifteen employees and save all of the payment requests in a single payables file 314. In one embodiment, the payables file 314 includes the same data as the Make Payments interface 200. Sending a single payables file 314 electronically to the PDH 102 saves time and eliminates the need for each individual Payer to manually schedule payment requests.

The PDH 102 will manage processing of all payment requests either entered manually through the Make Payments interface 200 or uploaded via a payables file 314. Unlike a conventional bill pay system where the payment request would be converted to a Direct Deposit Account (DDA) transfer, a check, and so on, to pay for monies owed, the PDH 102 will transact each of the scheduled payment requests as a credit card transaction.

FIG. 3 illustrates that the PDH 102, in one embodiment, passes the payment request to the Acquirer Gateway 108. As described above, the payment request contains information designating the specific Acquirer Processor. The Acquirer Gateway 108 then passes the payment request to the designated Acquirer Processor. FIG. 3 illustrates that Acquirer Gateway 108 communicates with three Acquirer Processors: Acquirer Processor 1 304, Acquirer Processor 2 306 and Acquirer Processor 3 308. The technology described herein is not limited to any specific number of Acquirer Gateways or Processors.

In an alternative embodiment, the PDH 102 communicates directly with each of the Acquirer Processors (shown in FIG. 3 by dashed lines). Thus, the Acquirer Gateway 108 is not required in the system 300. For example, the PDH 102 may communicate directly with each Acquirer Processor designated in the payment request. FIG. 3 illustrates that the PDH 102 may communicate directly with either Acquirer Processor 304, Acquirer Processor 306 or Acquirer Processor 308. In one embodiment, the PDH 102 passes the payment request to the Acquirer Processor or Acquirer Gateway 108 via HTTPS. The PDH 102 may, however, communicate with each Acquirer Processor or Acquirer Gateway 108 via any communication standard. For purpose only of describing the technology herein, the card transaction process will be described through a system using an Acquirer Gateway. However, as discussed above, the processing system is not required to include an Acquirer Gateway.

After login and authorization of the digital certificate (if one was issued), the PDH presents an electronic credit card payment form that preferably in a format recognized by the Acquirer Gateway 108 (or Acquirer Processor). The Payer may designate the Payee in each payment request in many ways. For example, the Payer may designate the Payee by a Payee identification, merchant identification (ID), company name and/or contact person. If the Payee's merchant ID is not known by the Payer, the PDH locates the Payee's merchant ID based on the Payee ID and includes the Payee's merchant identification in the payment request that is routed to the Acquirer Gateway.

The PDH queues multiple payment requests with the same credit card number and waits for a final authorization from the issuer processor (entity that authorizes and settles payments on behalf of the issuing bank) before another payment request in the queue is submitted. Consequently, the PDH 102 queues the payment requests and awaits a response from the Acquirer Gateway 108 in order to prevent unnecessary submissions to the card network on subsequent payments that are very likely all to be declined. This prevents unnecessary fees being charged by all processors in the card network, which depending on the contractual relationships, would likely be charged to either the issuing bank or the merchant. In addition, the PDH is saving the Payer from a lot of unnecessary work to deal with all the payments that would have been declined that should not have been submitted. The payer can view the progression of the authorization queue at the PDH after submitting the payment request.

FIG. 4 illustrates an alternative process 400 of communication between the payer and the PDH. Whereas FIG. 1 shows the topology of communication between the payer and the PDH wherein the payer communicates to the PDH via a web browser, FIG. 4 shows the topology of communication between the payer and PDH wherein the payer communicates with the PDH via the transmission of files using a file transfer protocol. In embodiments, this file transfer protocol may comprise AS2 (as pictured) or SFTP.

AP System 402 is the Accounts Payable system belonging to the payer, comprising one or more computers (such as that described in FIG. 19), such that the payer can upload files into the computer/s and receive notifications from the computer/s. Connected to AP System 402 is AS2 Directory 404, which functions as temporary storage for files before they may be transported via the AS2 protocol. In other embodiments, AS2 Directory 404 may be replaced by one or more directories appropriate for another file transfer protocol, such as SFTP.

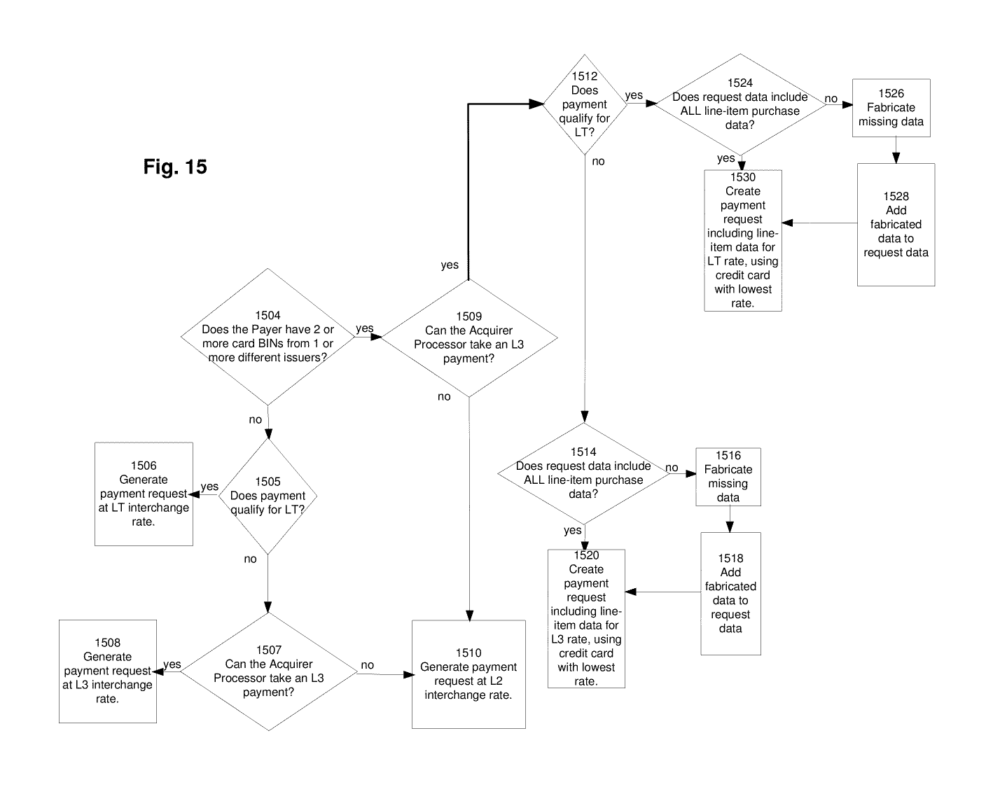

The AP System 404 may use an AS2 (or other) file transfer protocol to send a payables file 406 to the AS2 Directory 408 of PDH 410. The payables file 406 contains payment request data such as that shown in data 1504 of FIG. 15, as will be explained in more detail later. Upon transport, the file transport protocol may provide security or file checking features to ensure that the transported file is free from external tampering or errors. The AS2 Directory 408 of the PDH is similar in function to AS2 Directory 404 of the payer's AP System 402. AS2 Directory 408 stores payables files until they are to be processed by the PDH. Upon receiving the payables files, AS2 directory (PDH) 408 sends AS2 Directory 404 (payer's AP System) a batch confirmation file 414 via the FTP, confirming receipt of the file. Some embodiments may email this confirmation to the payer without using the FTP, whereas others may make the confirmation available to download via a PDH reports interface. In some embodiments, if the payment date contained in payables file 406 is the current date (i.e. the date on which the file is received), then payables file 406 is processed immediately by PDH 410, without being queued in the Pending queue of PDH 410.

Upon processing the payables file 406 in a manner such as that depicted in FIGS. 4-18, the PDH 410 submits output data to card network 416 through the Acquirer Processor (not pictured). Upon settlement of the payment, AS2 directory 408 often sends a settlement file 420 to AS2 directory 404 for reconciliation of the payment that often contains more detail about the line item data (aggregated invoice data) than is available through the settlement file from the issuer 418. Furthermore, after the settlement, the Acquirer Processor may make the settlement data available to the issuer 418 and supplier 417.

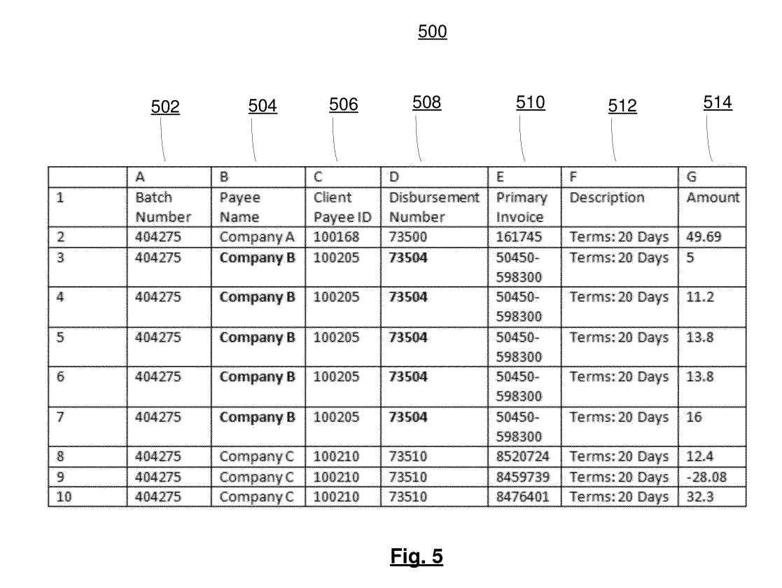

FIG. 5 illustrates an exemplary batch file 500 into which the payer enters information which may be included in the payment request data sent to the PDH in payables file 406 of FIG. 4. File 500 features 9 payments to 3 payees, namely, Company A, Company B, and Company C. Embodiments of the batch file may be used to make an arbitrary number of payments to an arbitrary number of payees. Column 502 lists the batch numbers, where each batch number designates the batch with which each payment in the corresponding row will be processed. In this example, the featured payments have the same batch number ‘404275’. Column 504 provides the payee name, whereby for a given row, the payee name designates the payee for which the payment described by that row is destined. Column 506 lists the client payee ID's, which are code numbers designating the payee which is named, for a given row, by the payee name under column 504 in that row.

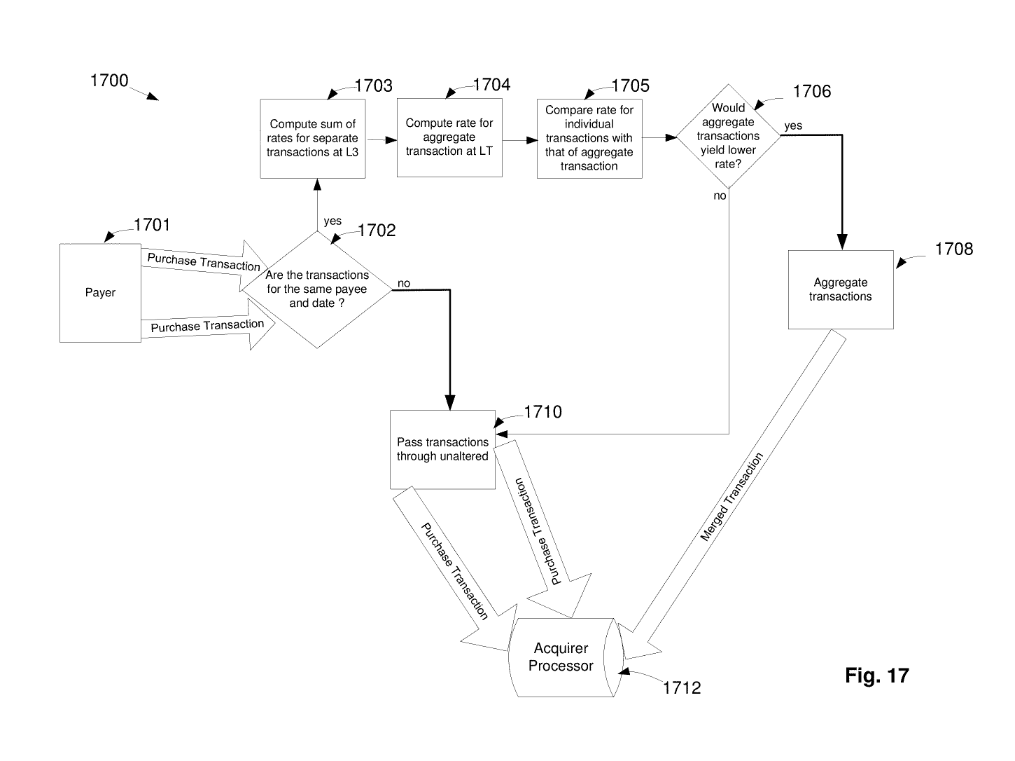

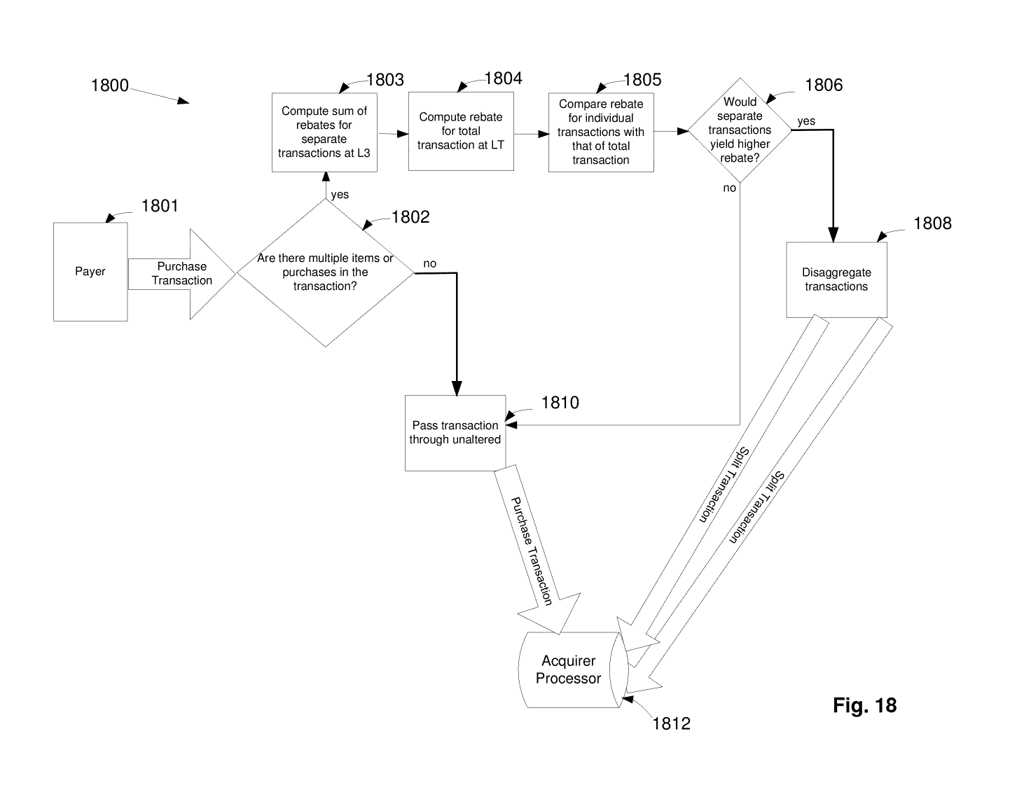

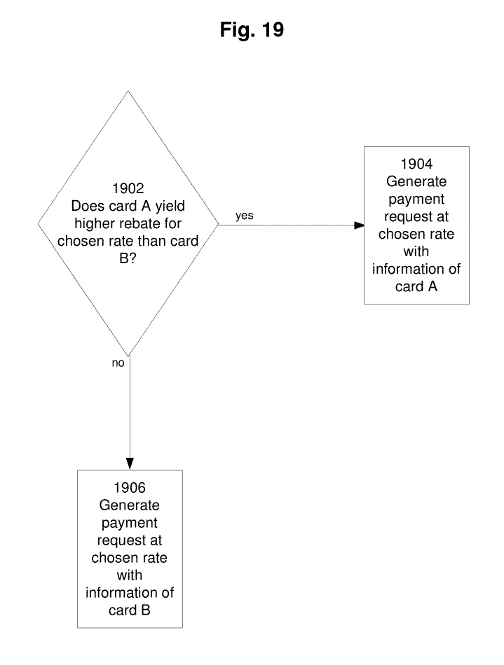

Column 508 lists the disbursement numbers, which, for a given row, designate the collection in which the payment of that row is processed. For example, rows 3-7 are payments to Company B, and they are listed under the same disbursement number 73504 (payee name and disbursement number for these rows are in bold for emphasis). Thus, payments 3-7 will be treated as a single payment by the system. Disbursement numbers 508 provide a means by which the payer can manually decide which payments to aggregate. Thus, in this example, by having the same disbursement number, payments 3-7 are aggregated. A method by which the system may automatically aggregate payments is described in FIG. 17. In some embodiments, manual aggregation decisions, such as those enabled by placing payments under a common disbursement number, may override aggregation decisions, such as those depicted in FIG. 17, which are made automatically by the system. In further embodiments, the system may disaggregate payments, using methods such as that described in FIG. 18, if the system finds it is more suitable to do so in order to meet payer goals, such as may be indicated by routing options such as LR, HR, BRLR, or LCR. For example, the system may disaggregate payments if the payments were set to route at HR, since the most likely scenario for doing so would be to ensure that payments are routed at L3 or higher interchange rates (and rebates) rather than at LT.

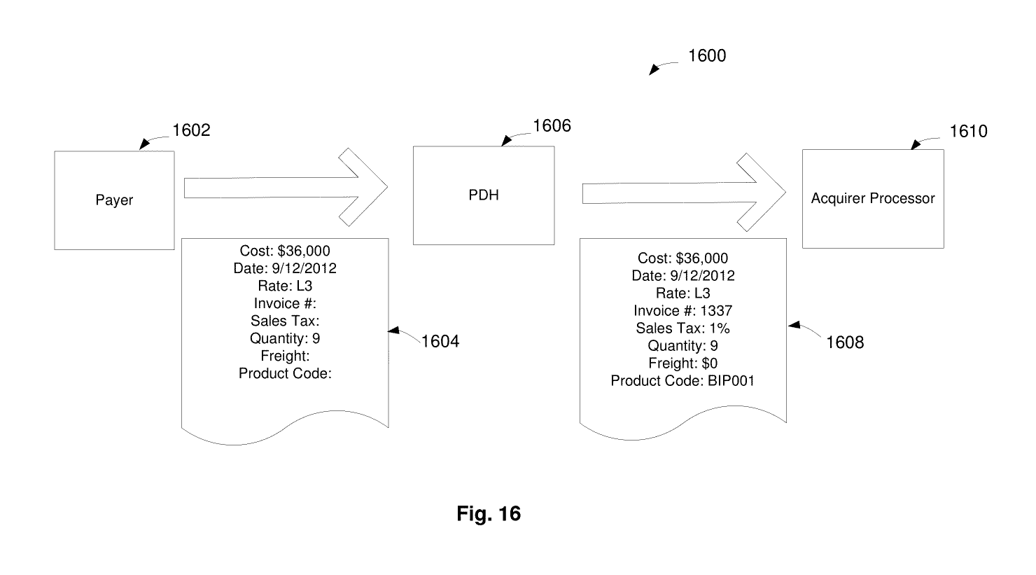

Column 510 lists the primary invoices for the payments of the corresponding row. A number in column 510 may have designated the payment of the corresponding row in the original invoice sent by the payee to the payer for a purchase made of the payee by the payer. Column 512 lists the descriptions which the payer may provide for the payment in a given row. Such a description is an example of line-item information which may be used to secure an L3 or LT interchange rate for the payment. Column 514 lists the amount of money to be paid in the currency of the transaction for the payment of the corresponding row. In embodiments, the amounts reflected by the entries in column 514 may be added together in the final payment request if the payments of the corresponding rows are aggregated, either by having a common disbursement number provided by the payer or automatically aggregated by the system. In further embodiments, additional columns or alternative data structures may be available in order to allow the payer to enter line item data such as sales tax, SKU number, quantity, freight, etc., such that the system need not fabricate such data (as per FIG. 16) in order to qualify for L2, L3 or LT rates.

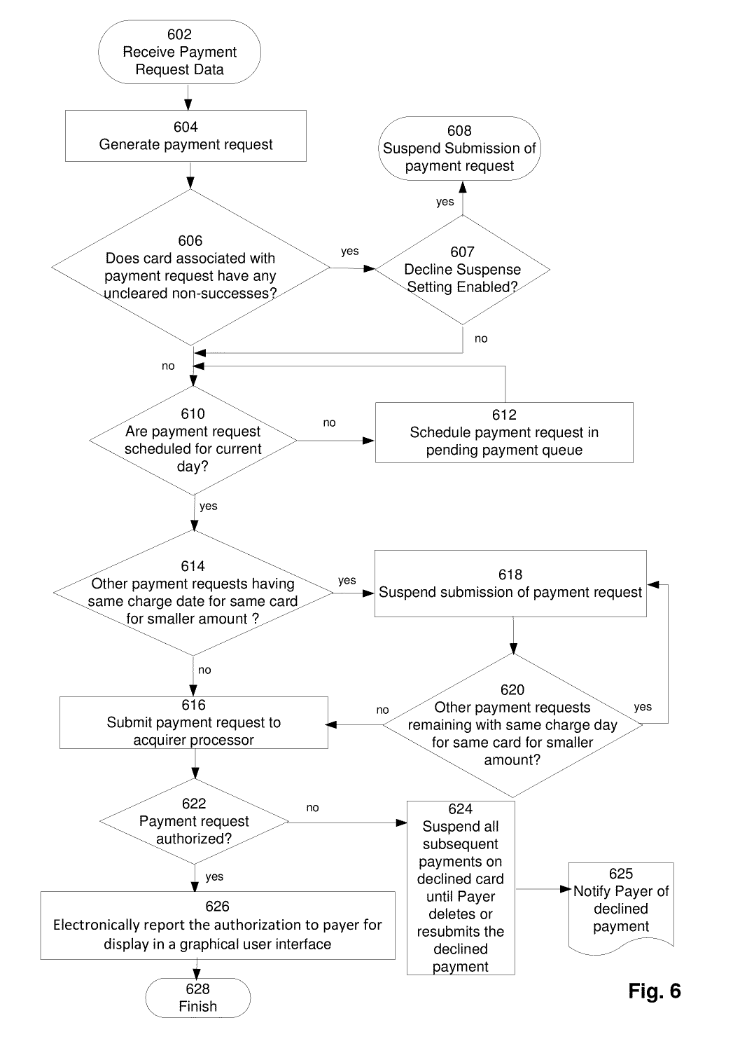

FIG. 6 illustrates a flow diagram providing exemplary steps describing one embodiment of credit card processing. In step 602, the PDH 102 receives new payment request data from the Payer 104. As discussed above, the Payer 104, in the Make Payment user interface 200, has entered the charge amount, the charge date and has designated the credit card to charge the payment against. The Payer 104 must also designate the Payee. In one embodiment, the Payer 104 designates the Payee by the Payee's unique Payee identification. In an alternative embodiment, the Payer designates the Payee from a pre-set Payee list.

In one embodiment, once a Payee is registered with the PDH, the Payee is available to all Payers within the Payer company. For example, if Company A registers Company B with the PDH 102, Company B is available to all of Company A's employees. In another embodiment, once a Payee is registered, there will be a company payee list as well as an individual payer list. For example, each Company A employee could access a Payee list that consists of the Payees the employee personally registered, and other Payees registered by fellow employees (if they pay the same vendor). That is, each Payee list will be customized according to the Payees that each Payer pays on a recurring basis. In other embodiments, the Payee becomes available to some or all Payers and is visible on the Payee lists of these Payers upon being registered with PDH 102. For instance, the Payee may be registered with PDH 102 by a Payer or an Acquiring Processor.

Upon receipt of the new payment request from the Payer, the PDH 102 generates payment a payment request based on the payment request data, in step 604. For example, the PDH 102 generates a payment request for the payment request data designating Company B as the payee. The PDH 102 retrieves the credit card information associated with the payment account, the charge date, and the charge amount entered by the Payer. The PDH bundles the merchant identification (ID) and acquirer processor identification associated with the Payee with the retrieved information. Thus, the payment request to Company B, in one embodiment, includes the credit card information associated with the payment account, the charge date, the charge amount, the Payee's merchant ID and the Payee's designated processing platform (e.g., Acquirer Processor or Acquirer Gateway). The payment request is not limited to this specific information and may include any other information that may help in tracking or processing the payment request.

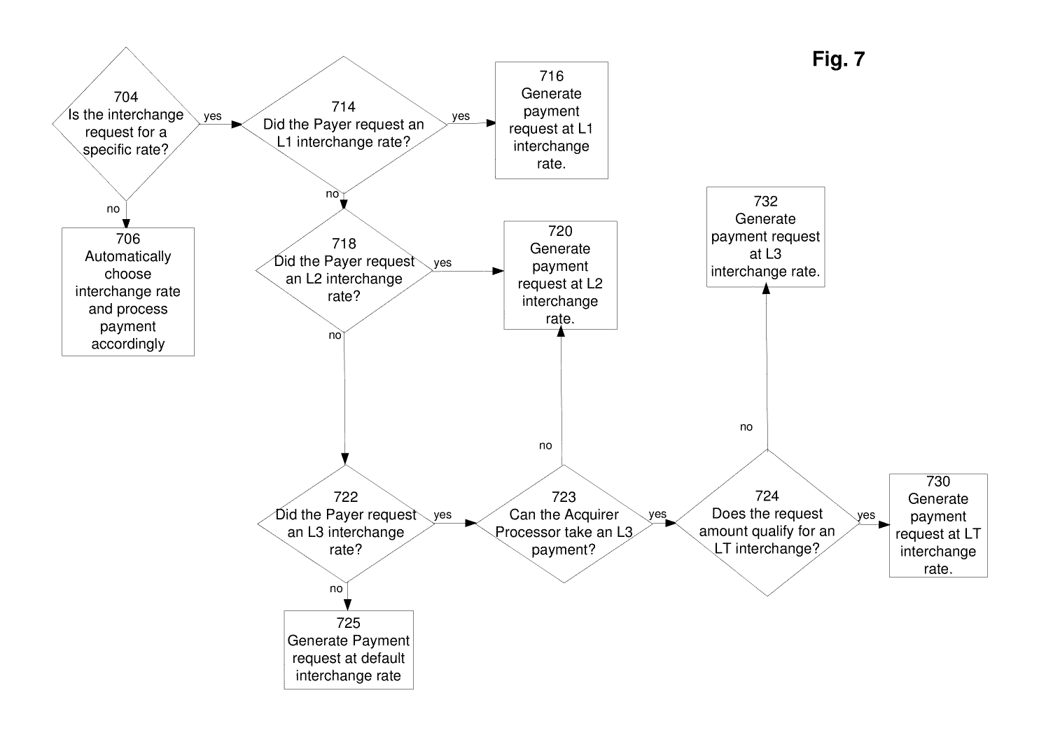

The Payer does not need to know the Payee's merchant ID or processing platform. In one embodiment, the Payer selects the Payee's name from a Payee list. In an alternative embodiment, the Payer identifies each Payee by a unique Payee identification number generated by the PDH 102. For example, the PDH may generate a unique Payee ID when the Payee is registered with the PDH. By way of example only, the PDH 102 generates the Payee ID based on the Payee's merchant ID. Furthermore, FIG. 7 expands upon the process by which the system may incorporate interchange information from the payer-submitted request data into the payment request generated by step 604.

In step 606, the PDH 102, after generating the payment request (Step 404), determines if the credit card number designated in the new payment request has any uncleared non-success conditions. In one embodiment, a non-success condition may comprise a decline associated with the credit card number. In an alternative embodiment, a non-success condition may comprise a prior failure associated with the credit card number. If the PDH 102 determines in step 606 that the credit card number does have a non-success condition associated with it, the PDH 102 will proceed to step 607 (to be discussed in more detail later). In step 607, the PDH 102 determines if a Decline Suspend setting has been enabled by the Payer (e.g., which the Payer has set in a user profile screen). If the Payer has enabled the Decline Suspend setting, the PDH 102 proceeds to step 608. In step 608, the PDH 102 suspends submission of the payment request. If, however, the Payer did not enable the Decline Suspend setting, the PDH 102 does not suspend the payment request and proceeds to step 610.

The PDH 102 will also proceed to step 610 if the PDH 102, in step 606, determines that the credit card information does not have a non-success associated with it. In step 610, the PDH 102 determines if the new payment request is scheduled for submission to the Acquirer Gateway 108 on the current day. In one embodiment, the submission day is equivalent to the charge date discussed above. For example, the payment request to Company B is scheduled to be submitted to the Acquirer Gateway 108 on Nov. 4, 2007. Suppose the payment request for Company B was generated on Nov. 1, 2007. In step 610, the PDH 102 will determine that the new payment request is not scheduled to be submitted to the Acquirer Processor 108 on the current day (Nov. 1, 2007). Thus, the PDH 102 places the new payment request to Company B in a pending payment queue, in step 612. When it is Nov. 4, 2007 (e.g., 12:01 am on Nov. 4, 2007), the PDH 102 continues to step 614.

The PDH 102, before submitting the payment request for Company B to the Acquirer Gateway 108, determines whether there are any other pending payment requests with the same credit card number for a smaller charge amount, in step 614. For example, the PDH 102, before it submits the payment request for Company B to the Acquirer Gateway 108, determines if there are any pending payment requests with the same credit card for less than the charge amount. If the payment request for Company B comprises the smallest charge amount associated with the credit card on Nov. 4, 2007, then the PDH 102 will submit the payment request for Company B to the Acquirer Gateway 108, in step 616.

In step 622, the PDH 102 waits for an authorization response from the Acquirer Gateway 108 in response to the just submitted payment request for Company B. As previously discussed above, the authorization response has three conditions: authorized, declined and failed. A decline condition is a violation of a very specific card parameter and failure has little to do with the card. A failure condition is usually a processing failure of the network anywhere between the Acquirer Gateway and the issuing processor (or back again). Failure conditions can also be due to invalid data or incorrectly formatted data being passed by one party to the next party. If the PDH 102, in step 622, receives an authorized response from the Acquirer Gateway 108, the PDH 102 continues to step 626. If the PDH 102 receives either a declined response or a failure response from the Acquirer Gateway 108 in step 622, the PDH 102 continues to step 624.

The PDH 102 submits payment requests including the same credit card number serially to the Acquirer Gateway 108. For example, the PDH 102 will wait for an authorization response from the Acquirer Gateway 108 in response to the payment request for Company B (payment N) until the PDH 102 submits the next payment request (payment N+1) to the Acquirer Gateway 108 with the same credit card. Thus, in step 614, the PDH 102 determines that there are other pending payment requests (payments N+1, N+2, N+3 . . . ) designating the same credit card and are for the same Submit On date (Nov. 4, 2007), the PDH 102 proceeds to step 618. In step 618, the PDH 102 suspends the submission of the payment request for Company B to the Acquirer Gateway 108. The payment request to Company B will remain suspended until the PDH 102 determines, in step 620, that there are no other payment requests designating the credit card scheduled to be submitted to the Acquirer Gateway 108 on Nov. 4, 2007 for an amount less than the amount of the payment to Company B. When the PDH 102 determines that the payment request to Company B includes the smallest amount associated with the credit card to be submitted to the Acquirer Gateway 108 on Nov. 4, 2007 (step 620), the PDH 102 will submit the payment request for Company B to the Acquirer Gateway 108, in step 616.

The process of submitting payment requests associated with the same credit card number to the Acquirer Gateway 108 in ascending order of charge amount provides several advantages. For example, submitting payment requests with the same credit card number serially to the Acquirer Gateway 108 in order from the smallest charge amount to the largest charge amount provides the opportunity for the issuer processor to authorize a maximum number of payment requests until the Payer, by way of example only, exceeds the credit limit associated with his issued commercial credit card.

Each credit card transaction generates interchange fees. Thus, the number of payment requests authorized by the issuer processor directly affects the revenue for the issuing banks and the Payer. Submitting payment requests designating a common credit card number to the Acquirer Gateway 108, one at a time, in order from the smallest payment to the largest payment, allows the PDH 102 to maximize the amount of interchange fees an issuing bank collects and maximizes the revenue share (percentage of interchange fee paid to Payer by issuing bank, also known as a rebate) collected by the Payer in a processing period. The issuing bank or merchant may also avoid unnecessary processing fees associated with the submission of payment requests on a card that has previously been declined for velocity violations (number of transactions allowed per cycle) or credit limit. This revenue is maximized while allowing as many Payees to be paid as possible. The payment requests may, of course, be submitted to the Acquirer Gateway 108 in any order.

In step 622, the PDH 102 waits for an authorized notification from the Acquirer Gateway 108 in response to the just submitted payment requests for Company B. If the PDH 102, in step 622, receives an authorized notification from the Acquirer Gateway 108, the PDH 102 continues to step 626. If the PDH 102 receives a non-success condition from the Acquirer Gateway 108 in step 622, the PDH 102 continues to step 424.

In step 624, PDH 102 may suspend the declined credit card, preventing any further payments on that card until the payer fixes or removes the failed payment. From step 624, PDH 102 may transition to step 625, in which PDH 102 will inform the payer that the attempted payment was declined. In further embodiments, steps 624 and 625 may be replaced with processes by which PDH may determine the reasons and conditions for the payment decline, and take different actions based on those reasons and conditions for payment decline, possibly including suspension of payments on the card and notification to the payer of the decline.

PDH 102, and systems similar to PDH 102, are typically used to generate and transmit payment information without reference to payer interests such as rebates or supplier interests such as interchange rates. FIGS. 7-11 will show exemplary decision logic, which, when appended to programs such as those of PDH 102 and like systems, can use information pertaining to interchange rates and rebates to take steps to route payments accordingly.

The disclosed technology involves selection of desired interchange rates by the payer. In some embodiments, a system such as PDH 102 may decide whether the selection of interchange rate is suitable for a payment request given parameters such as the amount of money being paid in the payment and the payee's willingness to accept the selected interchange rate. If the system decides that the selection is suitable, it may then route the payment at that interchange rate. According to industry standard, a payment can be routed at one of the following interchange rates: L1, L2, L3, or Large Ticket (LT). While the description herein applies to the L1, L2, L3, or LT rates, since these are industry standard in the United States of America for a commercial card or purchase card, embodiments of the presently disclosed technology, as practiced in other countries, may use other rates, including a flat interchange rate.

L1 rates tend to be the highest for the payee, and for which card networks tend to grant the payer the highest rebates. They also usually require little to no supplementary information with the payment request data.

L2 interchange rates are usually lower than L1 rates, and, consequently, generally earn lower rebates for payers than L1 rates. To be processed at an L2 rate, a payment must generally be supplemented with data corresponding to the sales tax for the payment. The content of the tax data itself is usually ignored, so placeholder tax data generally suffices to earn an L2 rate.

L3 interchange rates tend to be lower than L1 or L2 rates, but earn even lower rebates for payers than L1 or L2. Along with requiring tax data, like L2, L3 payments can usually only be processed if line item data, such as the freight charges and the Stockkeeping Unit (SKU) number of the item being purchased, accompanies the payment request. As with the tax data for L2 rates, this supplementary data is not actually used, and so may be arbitrary. While not necessarily favored by payers because of low rebates, many payee companies prefer L3 interchange rates to the point of not accepting any higher rates, such as L1 or L2. However, the Acquirer Processors of some payee companies are unable to process L3 payments, and in cases wherein the payee companies do not provide the correct terminal or internet application for submitting the line item data necessary for a payment to qualify for L3 data, the payee may not be able to submit L3 payment request data.

LT interchange rates tend to be the lowest, with the lowest rebates for payers. For LT rates, payment requests usually require the same supplementary purchase data as L3 such that, as before, the data itself is simply discarded. However, card networks also generally acquire that the payment, whether for one or more purchases, must exceed a certain minimum monetary amount in order to qualify for the LT rate.

Some embodiments of the disclosed technology may not require an explicit payer request for a certain interchange rate in order to route a payment. Rather, the system may automatically select an interchange rate for a given payment request based on criteria supplied by the payer along with the payment request data.

For instance, a payer may be interested in helping the payee pay a low interchange rate, but may not wish to specifically decide which interchange rate to request for the payment, or choose a lower interchange rate than necessary. In such an instance, the payer may wish to select a Lowest Rate (hereinafter referred to as “LR”) option. According to LR, the system may determine the lowest interchange rate previously used (through the PDH) by any payer for the payee, and, if the payment qualifies, route it at that rate. Embodiments of the technology may, if the payment does not qualify for the lowest interchange rate previously used by any payer for the payee, check other rates previously accepted by the payee in increasing order until the payment qualifies for a rate, and then route it at that rate.

In other cases, the payer may wish to obtain the highest rebate attainable for a given payment. Since, as discussed above, rebate correlates strongly with interchange rate, the payer may wish to indicate Highest Rate (hereinafter referred to as “HR”). According to HR, the system may determine the highest interchange rate previously accepted by the payee for any payer, and route the payment at that rate. If, however, the payment does not qualify for the determined rate, embodiments of the technology may check other rates previously accepted by the payee in decreasing order until the payment qualifies for a rate, and then route it at that rate.

Though the payer may wish to maintain positive relations with the payee by making payments at a low interchange rate, the payer may still wish to obtain a high rebate. If the payer has at least two credit cards from at least two issuers, then the payer may wish to choose the Best Rebate and Lowest Rate (“BRLR”) option, wherein the system determines the lowest interchange rate previously accepted by the payee and any payer (as in LR) and for which the payer qualifies. Then, for this rate, the system selects the card available to the payer that offers the best rebate for the rate, and then routes the payment at that rate with that card.

In some cases, the payer may wish to choose the Least Cost Routing (“LCR”) option, wherein, if the payer has access to multiple card BINS, the system may route the payment at the LT rate if it qualifies, L3 or the lowest qualifying if it does not, and, if the payer has access to the Visa Large Purchase Advantage Card BIN, uses it to obtain the lowest rate. In embodiments, other card BINs may be preferred.

Though the following explanation of the drawings will describe the process of payment requests using the options discussed above (i.e. LR, HR, BRLR, and LCR), the disclosed technology is not limited thus, and may enable the system to make payments using other criteria.

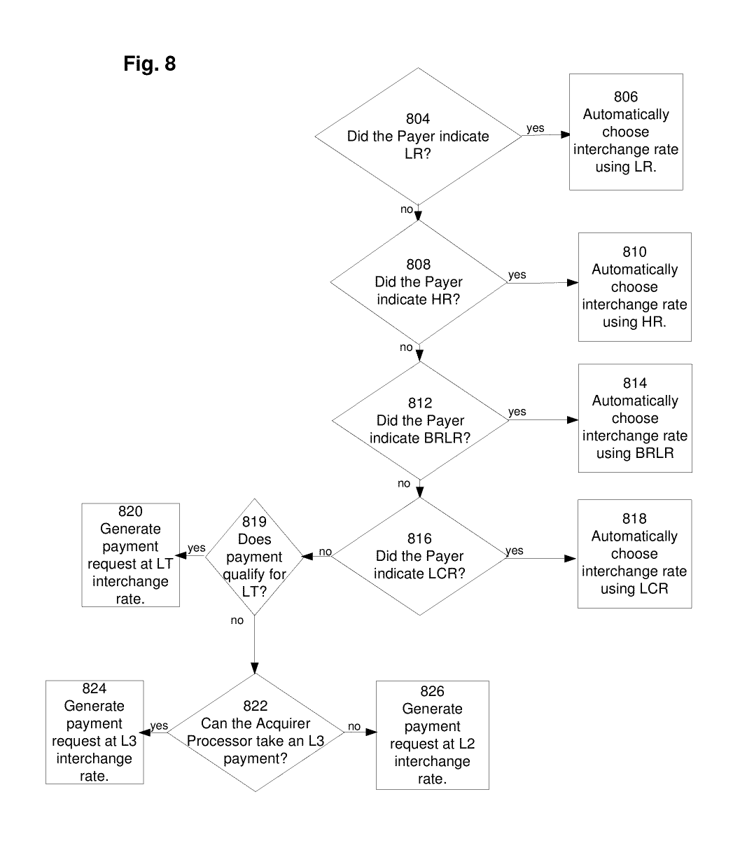

In one embodiment, the user interface of FIG. 2 will include a drop down menu (or other means) for the payer to select an interchange request. Alternatively, the drop down menu may be on the supplier profile screen. In another embodiment, the option to request an interchange rate may be a file attribute in a payment file that may be submitted to the system using file transfer protocol/s, as explained in FIG. 4. For example, the payer can select whether the transaction should be L1, L2, L3, LT, LR, HR, LCR, or BRLR. Once the payer has finished entering all the information needed for PDH 102 to process the payment, the payer may submit the request data to PDH 102. This data possibly includes the amount to be paid, designated payee information, payment date, and interchange rate request. This data may be submitted in one of many electronic file formats. In response to the payer submitting the payment request data, PDH 102 (upon receiving the transaction) will attempt to process the transaction as per the flow chart of FIG. 5. The process depicted in FIG. 7 accounts for interchange request data and explains in greater detail step 604 of FIG. 6, whereby the system (i.e. PDH 102) transforms payer-submitted payment request data into a full payment request that may be submitted to the Acquiring Processor in step 616 of FIG. 6. In step 704, the system determines whether the payment request includes a specific interchange request (e.g., L1, L2, L3, or LT). If the payment request data does not include an explicit interchange request, then the system will use the default option from the supplier's profile screen (L1, L2, L3, LT, LR, HR, BRLR, or LCR) by which the system may automatically generate and route a payment request. The PDH transitions to step 706, in embodiments of which the system proceeds to automatically choose the interchange rate given an indication (i.e. for LR, HR, BRLR, LCR) supplied by the payer, and processes the payment data as necessary to generate a payment request that accommodates the payer's preference. Greater detail regarding step 706 is provided in FIG. 8. If the payment request data does include a preference for a specific interchange rate, then the system transitions to step 714, which starts the process of checking which interchange rate the request for and whether or not the request qualifies. The user may have selected the interchange request via the drop down menu mentioned earlier or via setting a file attribute on the payment file to be submitted to the PDH via the FTP (as per FIG. 4). Alternatively, the supplier profile screen may have a default value for the interchange rate, at which the payment may be processed unless the payer manually overrides the default rate with a preferred rate.

In step 714, the system checks whether the payer has requested an L1 interchange rate. If so, the system moves to step 716, in which the system generates a payment request at the L1 interchange rate. If the request is not for L1, the system moves to step 718.

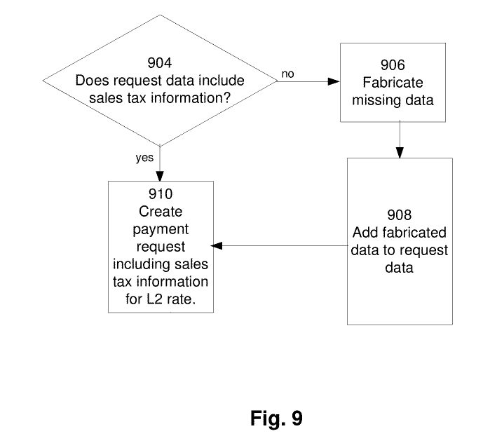

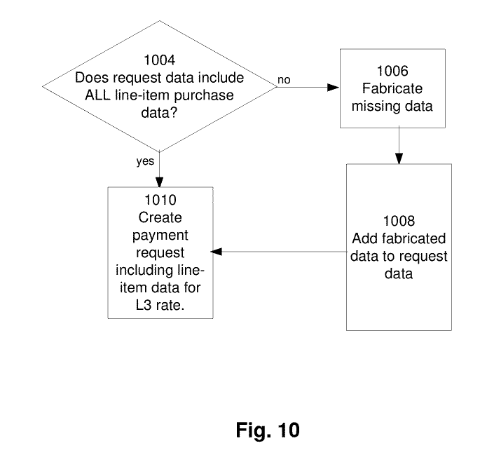

In step 718, the system checks whether the payer has requested an L2 interchange rate. If so, the system moves to step 720 (more detail in FIG. 9), in which the system generates a payment request at the L2 interchange rate. If the request is not for L1, the system moves to step 722.

In step 722, the system checks whether the payer has requested an L3 interchange rate. If not, the system moves on to step 725, in which the system generates and routes a payment request at a default interchange rate, since at this point it is assumed that the payer has not provided an indication (LR, HR, BRLR, LCR) for automatic routing, nor has the payer overridden any default interchange rates set for the payment by the system. In some embodiments of step 725, the system attempts to process the payment at an LT rate as the default rate. The system may check whether various aggregations (as explained in FIG. 17) of payments queued for the same Payee on the same day qualify for an LT rate, and routes them at LT if they do. If they do not, then the system may check if the Acquiring Processor of the designated Payee will accept L3 rates, as some may not be properly equipped or otherwise enabled to do so. If the Acquiring Processor will accept an L3 payment, then the system generates and routes a payment request at L3 for the transaction in question. Otherwise, the payment request will be generated and routed at L2. Other embodiments may have L1 or another interchange rate as the default rate. On the other hand, if the payer has requested L3, the system moves to step 723.

In step 723, the system may decide whether or not the Acquiring Processor of the Payee designated by the payer's payment request data can even accept L3 payments. Note that while some actual Acquiring Processors do not accept L3 payments, a check such as step 723 can in principle be used in embodiments for any interchange request. If the payee cannot accept L3 payments, then the system transitions to step 720, wherein the system decides to generate the payment request at an L2 interchange rate, since the L2 rate is typically the closest to L3. Other embodiments may instead generate the payment request at L1, or the default rate as described for embodiments of step 725. However, if the payee can accept L3 payments, the system transitions to step 724.

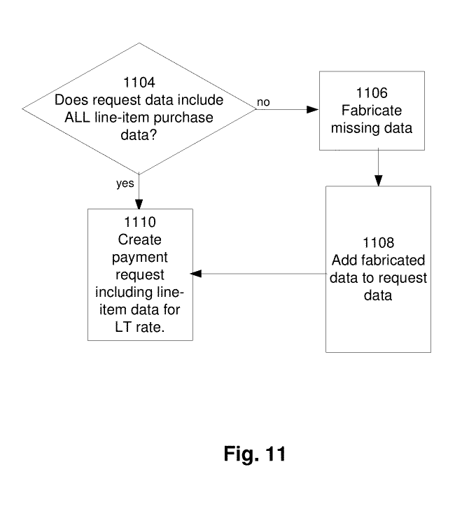

In step 724, the system may check whether or not the payment request constitutes an amount large enough to qualify for the LT interchange rate. In further embodiments, the system may aggregate (to be explained in more detail later on for FIGS. 17 and 18) payment request data in order to meet the requirements for LT interchange. However achieved, if the payment request does qualify for LT, the system generates a payment request at LT in step 730 (more detail in FIG. 11). Otherwise, if the payment request does not qualify for LT but does qualify for LT, the system then generates a payment request at the L3 rate in step 732 (more detail in FIG. 10). While this embodiment may assume that the payer would naturally prefer an LT rate, some embodiments may check explicitly whether or not the payer opted for an LT rate as opposed to an L3 or other interchange rate.

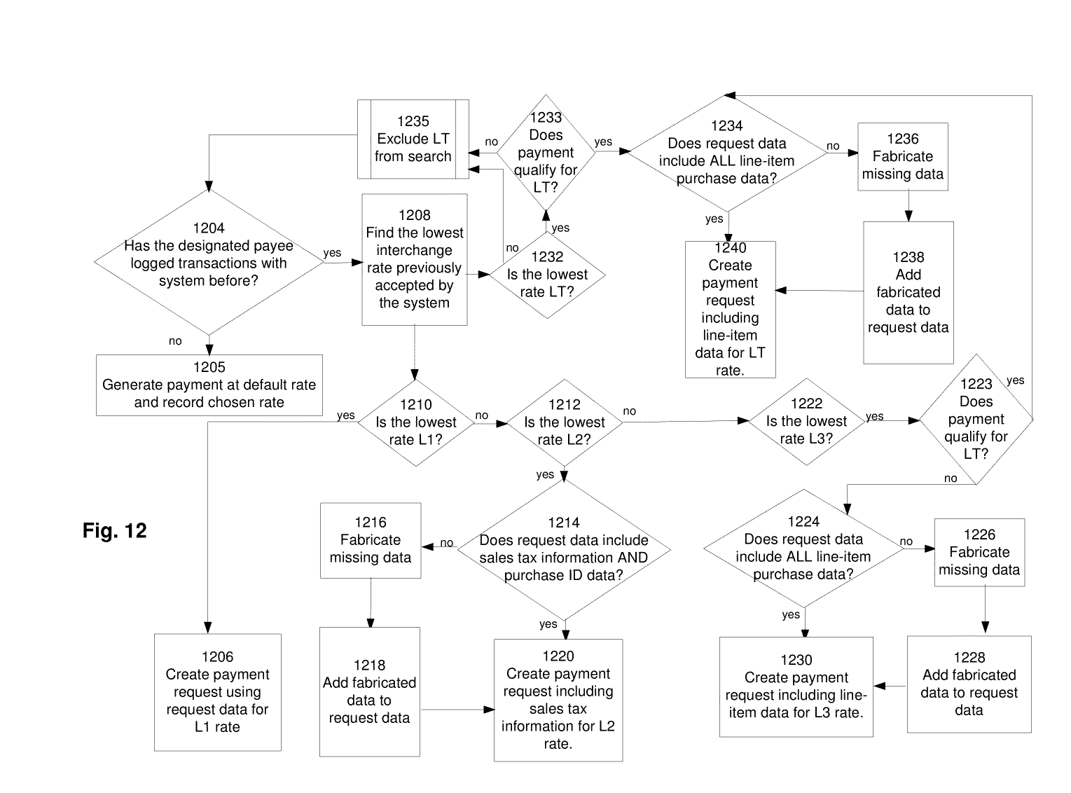

FIG. 8 is a more detailed explanation of step 706 of FIG. 7, wherein the system automatically chooses an interchange rate given an indication (i.e. for LR, HR, BRLR, or LCR) supplied by the payer with the payment data, and processes the payment accordingly. The process of FIG. 8 begins with step 804, wherein the system checks whether the payer has indicated the LR option in the payment request data. If so, the system transitions to step 806, wherein the system automatically selects an interchange rate and generates a payment request with that interchange rate, in accordance with the LR request. FIG. 12 explains step 806 in greater detail. If the payer has not indicated LR, the system transitions to step 808.

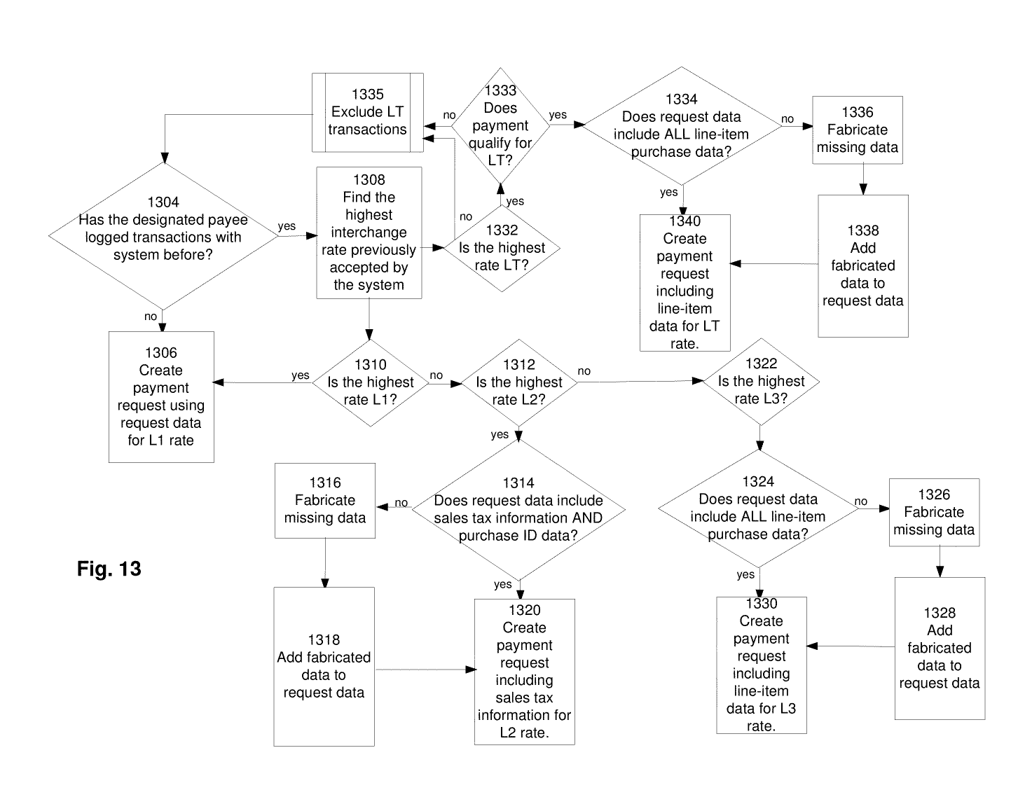

In step 808, the system checks whether the payer has indicated the HR option in the payment request data. If so, the system transitions to step 810, wherein the system automatically selects an interchange rate and generates a payment request with that interchange rate, in accordance with the HR request. FIG. 13 explains step 810 in greater detail. If the payer has not indicated HR, the system transitions to step 812.

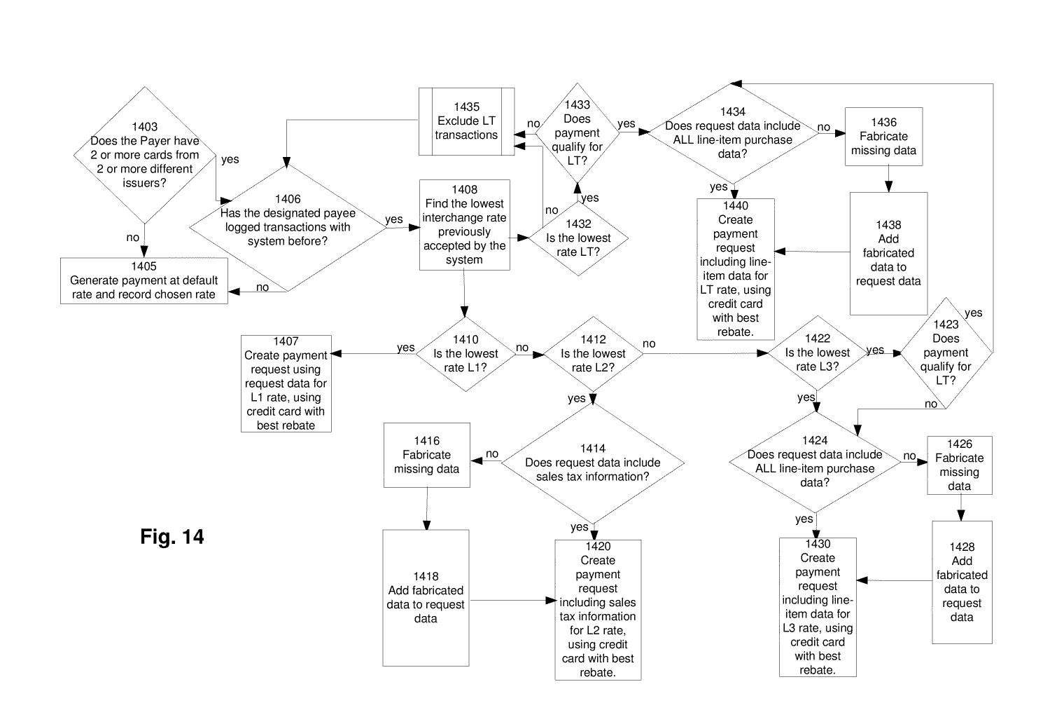

In step 812, the system checks whether the payer has indicated the BRLR option in the payment request data. If so, the system transitions to step 814, wherein the system automatically selects an interchange rate and generates a payment request with that interchange rate, in accordance with the BRLR request. FIG. 14 explains step 814 in greater detail. If the payer has not indicated LR, the system transitions to step 816.

In step 816, the system checks whether the payer has indicated the LCR option in the payment request data. If so, the system transitions to step 818, wherein the system automatically selects an interchange rate and generates a payment request with that interchange rate, in accordance with the LCR request. FIG. 15 explains step 818 in greater detail. If the payer has not indicated LCR, the system transitions to step 817, in which the system may generate and process a payment request at a default interchange rate. Specifically, in step 817, the system may check, as in step 724 of FIG. 7, whether or not the payment request data, perhaps aggregated with other payments destined for the same payee on the same date, qualifies for an LT rate. If it does, the payment request is generated at LT in step 820. Otherwise, the system transitions to step 822, in which the system determines whether the Acquirer Processor of the designated payee can accept L3 payments. If this is so, then in step 824, the payment request is generated at an L3 rate. Otherwise, the system generates the payment request at L2. In other embodiments, the default interchange rate may be L1 or another rate. Furthermore, embodiments of the present technology may allow for alternative options (i.e. beyond LR, HR, BRLR, and LCR) for automatically choosing the interest rate.

FIG. 9 is a more detailed explanation of step 720 of FIG. 7, wherein the system generates a payment request with an L2 interchange rate. Specifically, it addresses the method by which the system ensures that the request data is complete with the information required to qualify for an L2 rate. The process begins with 904, wherein the system checks whether the request data includes all the requisite information to qualify for the selected interchange rate. In the case of L2, this usually means the amount of sales tax to be paid with the transaction. If the payer has included this data, the system moves on to step 910, in which the system creates the payment request which includes the L2 rate and the information provided by the payer to qualify for this rate.

If, however, the payer has not included all requisite information to qualify for the desired interchange rate by step 904, the system transitions to 906, wherein the PDH fabricates data for the fields missing in the payment request data. In some embodiments, the storage will keep default values from which the processor can choose. For example, the PDH may fabricate a sales tax value for a certain amount or percentage for the sales tax field. In some embodiments, this tax entry may be fixed to a constant value across all parameters. Then, in step 908, the system inserts this fabricated data into its respective fields in the payment request data. Following step 908, the system transitions to 910, wherein the system generates a payment request that includes the fabricated data, which allows it to qualify for L2. In embodiments, the Acquirer Processor may process the payment by interchange rate based on the information (or lack thereof) it receives along with the payment. For example, if no additional data is provided along with the payment request, the Acquirer Process would automatically process the payment at an L1 rate. If only sales tax data but no other purchase is included with the payment request, the Acquirer Processor would process the payment at L2. If additional line-item data is provided, the payment routes at L3. If the payment request meets the L3 requirement and meets or surpasses the monetary amount threshold required for Large Ticket, the Acquirer Processor processes the payment at the LT interchange rate.

FIG. 10 is a more detailed explanation of step 732 of FIG. 7, wherein the system generates a payment request with an L3 interchange rate. Specifically, it addresses the method by which the system ensures that the request data is complete with the information required to qualify for an L3 rate. The process begins with step 1004, wherein the system checks whether the request data includes all the requisite information to qualify for the selected interchange rate. In the case of L3, in addition to the amount of sales tax to be paid with the transaction and the number identifying the purchase order or invoice as with L2, payment requests must usually include line-item data for the purchase's such as Stockkeeping Unit (SKU) and freight charges. If the payer has included this data, the system moves on to step 1010, in which the system creates the payment request which includes the L3 rate and the information provided by the payer to qualify for this rate.

If, however, the payer has not included all requisite information to qualify for the desired interchange rate by step 1004, the system transitions to 1006, wherein the PDH fabricates data for the fields missing in the payment request data. Then, in step 1008, the system inserts this fabricated data into its respective fields in the payment request data. Following step 1008, the system transitions to 1010, wherein the system generates a payment request that includes the fabricated data.

FIG. 11 is a more detailed explanation of step 730 of FIG. 7, wherein the system generates a payment request with an LT interchange rate. Specifically, it addresses the method by which the system ensures that the request data is complete with the information required to qualify for an LT rate. The process begins with step 1104, wherein the system checks whether the request data includes all the requisite information to qualify for the selected interchange rate. In the case of LT, the information required to supplement the payment request data is generally the same as that needed to qualify for an L3 rate. If the payer has included this data, the system moves on to step 1110, in which the system creates the payment request which includes the LT rate and the information provided by the payer to qualify for this rate.

If, however, the payer has not included all requisite information to qualify for the desired interchange rate by step 1104, the system transitions to 1106, wherein the PDH fabricates data for the fields missing in the payment request data. In some embodiments, the storage will keep default values from which the PDH can choose. Then, in step 1108, the system inserts this fabricated data into its respective fields in the payment request data. Following step 1108, the system transitions to 1110, wherein the system generates a payment request that qualifies for the LT rate with the fabricated data.

FIG. 12 depicts an embodiment of the process by which the system may handle LR requests from the payer. The process depicted in FIG. 12 may embody step 806 of FIG. 8, wherein the system is instructed to process a payment request for which the payer has specified the LR option. In order for the system to find the lowest interchange rate ever accepted by the payee designated in the payment request data, the system first verifies in step 1204 that the payee has previously accepted payments and recorded the interchange rates with the system. If the payee has not recorded an interchange rate with the system, then the system transitions to step 1205, in which the system attempts to generate and route the payment at a default interchange rate. In some embodiments, the system may be default attempt to route the payment, including with some aggregations involving payments destined to the same payee on the same date, at an LT rate. If no such aggregation, including the payment request data itself, qualifies for an LT rate, then in some embodiments the system may check if the Acquirer Processor for the designated payee can accept L3 rates. If so, the payment request may be generated and routed at L3, but if not, the system may generate and route the payment request at an L2 rate. Other embodiments may generate and process the payment at an L1 interchange rate. Some embodiments may use other default rates. If LR is set as the default option for routing payments, then whatever rate is used, the system will update its storage by marking the rate used for this transaction as the new lowest rate accepted by the payee. However, in embodiments wherein LR is chosen by the payer through the web interface or payment file, the system may instead attempt to route the payment at LT, L3, or L2 in that order of priority, as described above.

If, in step 1204, the system has found transactions previously accepted by the payee, it begins step 1208, in which the system searches for the lowest interchange rate. In some embodiments, the processor may sort a list of references to transaction files by the interchange rates from lowest to highest and select the interchange rate of the first item in the list.

The system may transition from step 1208 to step 1210, in which the system checks whether the lowest rate previously accepted by the payee is L1. If the lowest rate is L1, the system transitions to step 1206, wherein it generates a payment request at an L1 rate.

If L1 is not the lowest rate, then in Step 1212, the system checks whether L2 is the lowest rate. If L2 is the lowest rate, then the system begins the process of steps 1214-1220, wherein, much like steps 904-910 in FIG. 9, the system checks whether or not the payment request data provided by the payer includes all the supplementary data necessary to qualify for an L2 rate, and, if not, fabricates and adds it as appropriate before generating an L2 payment request.

If L2 is not the lowest rate, then in Step 1222, the system checks whether L3 is the lowest rate. If L3 is the lowest rate, then the system transitions to step 1223, in which it checks whether the payment, or various aggregations containing the payment, may qualify for an LT rate. If the payment does qualify for LT interchange, the system transitions to the process of steps 1234-1240, which, as will be explained later, allow the system to generate and route the payment at an LT rate. Otherwise, the system decides to process the payment at L3 and begins the process of steps 1224-1230, wherein, much like steps 1004-1010 in FIG. 8, the system checks whether or not the payment request data provided by the payer includes all the supplementary data necessary to qualify for an L3 rate, and, if not, fabricates and adds it as appropriate before generating an L3 payment request. Though in such embodiments, if L3 was the previously used rate, the system may decide to route the payment at LT if possible due to the similarity between the LT and L3 rates, other embodiments may eliminate step 1223 and have the system directly proceed from step 1222 to step 1224 to generate an L3 payment request.

In some embodiments, the system may check in step 1232 if the lowest rate interchange rate previously accepted by the designated payee is LT. If LT is not the lowest rate previously accepted by the Payee, the system may transition to step 1235, in which the system sets a condition to not repeat step 1232 for the current transaction, thus removing LT from consideration for the payment. The system then moves back to step 1204 to check if the payee has logged any transactions for L1, L2, or L3 rates at which the payment may be routed.

If, in step 1232, the system has found previous LT transactions accepted by the payee, then the system must further determine in step 1233 whether the current payment transaction actually qualifies for the LT rate, which usually requires the payment to pass some monetary threshold. If the single transaction does not qualify for LT, then some embodiments may test every combination of payments scheduled (i.e. queued in storage) for the same payee on the same date, and for any credit cards owned by the Payer, to determine whether an aggregation (explained in more detail later) of payments may qualify for an LT rate. If no payment or aggregation of payments qualifies for LT in step 1233, then the system transitions to step 1235, which restarts the process of searching for the lowest accepted interchange rate except LT.

If, in step 1233, the system determines that the payment or some aggregation of payments destined for the same payee on the same date meets the requirement for an LT interchange rate, then the system transitions to the process comprising steps 1234-1240, wherein, much like steps 1104-1110 in FIG. 11, the system checks whether or not the payment request data provided by the payer includes all the supplementary data necessary to qualify for an LT rate, and, if not, fabricates and adds it as appropriate before generating an LT payment request.

FIG. 13 depicts an embodiment of the process by which the system may handle HR requests from the payer. The process depicted in FIG. 13 may embody step 810 of FIG. 8, wherein the system is instructed to process a payment request for which the payer has specified the HR option. In order for the system to find the highest interchange rate ever accepted by the payee designated in the payment request data, the system first verifies in step 1304 that the payee has previously accepted payments and recorded the interchange rates with the system. If the payee has not recorded an interchange rate with the system, then in step 1306, the system automatically generates a payment request with the supplied data but with an L1 interchange rate. Some embodiments may use other default rates.

If, in step 1304, the system has found transactions previously accepted by the payee, it begins step 1308, in which the system searches for the highest interchange rate. In some embodiments, the processor may sort a list of references to transaction files by the interchange rates from highest to lowest and select the interchange rate of the first item in the list.

The system may transition from step 1308 to step 1310, in which the system checks whether the highest rate previously accepted by the payee is L1. If the highest rate is L1, the system transitions to step 1306, wherein it generates a payment request at an L1 rate.

If L1 is not the highest rate, then in step 1312, the system checks whether L2 is the highest rate. If L2 is the highest rate, then the system begins the process of steps 1314-1320, wherein, much like steps 904-910 in FIG. 9, the system checks whether or not the payment request data provided by the payer includes all the supplementary data necessary to qualify for an L2 rate, and, if not, fabricates and adds it as appropriate before generating an L2 payment request.

If L2 is not the highest rate, then in step 1322, the system checks whether L3 is the highest rate. If L3 is the highest rate, then the system begins the process of steps 1324-1330, wherein, much like steps 1004-1010 in FIG. 10, the system checks whether or not the payment request data provided by the payer includes all the supplementary data necessary to qualify for an L3 rate, and, if not, fabricates and adds it as appropriate before generating an L3 payment request.

In some embodiments, the system may check in step 1332 if the highest rate interchange rate previously accepted by the designated payee is LT. If LT is not the highest rate previously accepted by the Payee, the system may transition to Step 1335, in which the system sets a condition to not repeat step 1332 for the current transaction, thus removing LT from consideration for the payment. The system then moves back to step 1304 to check if the payee has logged any transactions for L1, L2, or L3 rates at which the payment may be routed.

If, in step 1332, the system has found previous LT transactions accepted by the payee, then the system must further determine in step 1333 whether the current payment transaction actually qualifies for the LT rate, which usually requires the payment to pass some monetary threshold. If the single transaction does not qualify for LT, then some embodiments may test every combination of payments scheduled (i.e. queued in storage) for the same payee on the same date, and for any credit cards owned by the Payer, to determine whether an aggregation (explained in more detail later) of payments may qualify for an LT rate. If no payment or aggregation of payments qualifies for LT in step 1333, then the system transitions to step 1335, which restarts the process of searching for the highest accepted interchange rate except LT. In some embodiments, if LT was the highest rate previously paid by the payee, but the current transaction does not meet the LT threshold, then the system will route the payment at L3 if the Acquirer Processor will accept L3 payments, and otherwise route the payment at L2.

If, in Step 1333, the system determines that the payment or some aggregation of payments destined for the same payee on the same date meets the requirement for an LT interchange rate, then the system transitions to the process comprising steps 1334-1340, wherein, much like steps 1104-1110 in FIG. 11, the system checks whether or not the payment request data provided by the payer includes all the supplementary data necessary to qualify for an LT rate, and, if not, fabricates and adds it as appropriate before generating an LT payment request.

FIG. 14 depicts an embodiment of the process by which the system may handle BRLR requests from the payer. The process depicted in FIG. 14 may embody step 814 of FIG. 8, wherein the system is instructed to process a payment request for which the payer has specified the BRLR option. In order for the system to actually offer BRLR, it must first verify in step 1403 that the payer has 2 or more credit cards from 2 or more issuers. If this is not the case, the system transitions to step 1205, wherein the system selects for the payment whichever card owned by the payer has the best rebate for LT transactions and, as described for step 1205 of FIG. 12, generate and route the payment request at the default interchange rate. For some embodiments, the system will prefer to route the payment at LT, but, should the payment not qualify for LT, routes at L3, and failing that, L2. In other embodiments, for example, the system may instead proceed as if the payer had requested LR for the transaction and/or arbitrarily select the credit card with which the payment is ultimately processed.

If, in step 1403, the system finds that the Payer has 2 or more credit cards from 2 or more issuers, then the system proceeds to step 1406, wherein, much like Step 1204 of FIG. 12, the system checks whether or not the designated payee has logged successful transactions with the system. If the payee has not done so, then the system transitions to step 1405 to generate and route the payment request at the preferred default interchange rate. In some embodiments, the PDH 102 may record in its storage that the chosen rate is the new lowest interchange rate at which future transactions may be routed. In other embodiments, the system ignores default values, and upon receiving any payment with the BRLR option selected (whether by browser or in payment file), will attempt to route the payment at LT, L3, and L2 in that order. Some embodiments of the system may choose the payment card with the best rebate after determining the interchange rate at which the payment will be routed, the choice of card depending on the interchange rate selected.

If the payee has a previous history with the system, then the system proceeds with steps 1408 and onwards, which much like steps 1208 and onwards of FIG. 12, find the lowest interchange rate previously accepted by the payee, and, if the payment or some aggregation of payments qualifies for the rate, fabricates and adds information as necessary to the payment request data, and generates a request from the data at the lowest rate. However, the main difference between BRLR and LR (as described above) is that for BRLR, the system also ensures that when generating a request, the credit card chosen for the payment request is the card that yields the highest rebate for the transaction.

FIG. 15 depicts an embodiment of the process by which the system may handle LCR requests from the payer. The process depicted in FIG. 15 may embody step 818 of FIG. 8, wherein the system is instructed to process a payment request for which the payer has specified the LCR option. In Step 1504, the system checks whether or not the payer has 2 or more credit card Bank Identification Numbers (BINs) from 1 or more issuers. If the payer does not have multiple card BINs, the system transitions to Step 1505, wherein the system sets the credit card information to that of the single card owned by the payer, and checks whether the payment, or some aggregation thereof, qualifies for an LT rate. If it does, then in step 1506, the system generates and routes the payment request at the LT interchange rate. Otherwise, the system transitions to step 1507, wherein it checks whether the Acquirer Processor for the designated payee can accept L3 payments. If the Acquirer Processor can take L3 payments, the system generates the payment request at L3 in step 1508, and otherwise generates the payment request at L2 in step 1510. If, at step 1504, the system determines that the payer does have multiple card BINs, the system transitions to step 1509.

In step 1509, the system checks whether the Acquirer Processor for the designated payee can take L3 payments. If not, the system transitions to step 1510 to generate the payment request at an L2 rate.

If the Acquirer Processor of the payee can accept L3 transactions, the system checks in step 1512 whether the payment or some aggregation containing it can qualify for an LT rate. If it can, the system proceeds to steps 1524-1530, wherein, much like steps 1104-1110 of FIG. 11, the system fabricates and adds purchase data as necessary before generating a payment request at LT. Some embodiments of the system may choose the card BIN which secures the lowest interchange rate for the payee.

If no payment or an aggregation containing it can qualify for an LT rate, the system proceeds to steps 1514-1520, wherein, much like steps 1004-1010 of FIG. 10, the system fabricates and adds purchase data as necessary before generating a payment request at L3. Some embodiments of the system may choose the card BIN which secures the lowest interchange rate.

FIG. 16 depicts a block diagram of process 1600 whereby the system may fabricate and insert data as needed to obtain interchange rates desired by the payer. Process 1600 may be employed during steps 906 and 908 of FIG. 9, steps 1006 and 1008 of FIG. 10, and steps 1006 and 1008. In such circumstances, the system may need to fabricate and add information to payment request data. While the data fields shown in FIG. 16 are generally applicable to requests for L3 and LT interchange rates, they may be modified as necessary to accommodate L2 rates.

In process 1600, payer 1602 uses a computer or some other kind of terminal to build and submit payment request data 1604. This exemplary payment request data contains data regarding cost of purchase (possibly as specified by the supplier invoice), the date of transaction, the interchange rate preferred, the quantity of items purchased for this transaction, and possibly a set of blank fields for other values. The values for the data fields as shown in 1604 are purely illustrative. Furthermore, the payment request data file may be embodied in any number of formats.

Exemplary system PDH 1606, which can be the same PDH system of FIGS. 1 and 3, takes as input the request data 1604 supplied by payer 1602. It performs processing, perhaps such as that depicted in steps 1106 and 1108 of FIG. 11, to produce payment request 1608. Request 1608 may retain the same fields and values as 1604, but fabricates and inserts arbitrary values for the invoice number, sales tax, and freight charge, using the conventional default for the product code. Again, the fields, values, and format shown are purely exemplary. Then, as described for step 616 of FIG. 6, PDH 1606 may pass the request file to the Acquirer Processor 1610, which handles the request as necessary. The transmitted payment may be in the form of a digital file.

FIG. 17 is a diagram showing one embodiment of the process 1700 by which the system may decide to aggregate payments and transmit aggregated payments to the Acquirer Processor. This aggregation may occur when the system is attempting to decide whether or not to process payments at LT, such as at step 724 of FIG. 7 (general), step 1233 of FIG. 12 (LR), step 1333 of FIG. 13 (HR), step 1433 of FIG. 14 (BRLR), and step 1512 of FIG. 15 (LCR). Additionally, the flow chart consisting of steps 1702-1710, enclosed by the dotted-lined box, represents an exemplary decision-making process used by a system such as PDH 1606 to determine whether and how to aggregate transactions. Payer 1701 may submit one or more transactions such as 1604 of FIG. 16 to a system such as PDH 1606. The system 1606 may then store these payments, possibly in a queue. In step 1702, system 1606 may determine whether it is storing payer-submitted transactions destined for the same payee on the same date. For example, the system may take step 1702 if the payments are requested for LT, LR, or LCR rates. If there is more than one transaction destined for the same payee on the same date, then in step 1703, system 1606 uses its one or more processors to calculate the total interchange rate that would be applied if the transactions were processed individually. While in the diagram the system considers L3 rates, further embodiments of the system may consider rebates for other interchange rates, possibly using a process such as that depicted in FIG. 10. In some embodiments of step 1703, the system may calculate such totals for each applicable credit card owned by the payer. Then, in step 1704, the system may use its processor/s to compute the interchange rate that would be imposed on the payee if the payments queued for the designated payee on the same date were aggregated. In further embodiments, the system may calculate the total interchange rates for some or all possible combinations of the queued transactions, and for some or all of the credit cards owned by the payer. Next, in step 1705, the system processor/s compare the rebate value computed in step 1704 with that obtained in step 1703. Some embodiments may perform this comparison per credit card owned by the payer. In step 1706, the system may decide on the basis of the comparison made in step 7505 whether or not, for at least one of the credit cards owned by the payer, aggregating the transactions in some way yields a lower interchange rate. For steps 1703-1706, some embodiments may choose other criteria to compare the transactions. For instance, for an HR request, the comparison may be done based on whether the aggregation does or does not yield a higher rebate, rather than a lower interchange rate. If the system has decided to aggregate received payment requests, then the system may go to step 1708, in which it aggregates the payments, adding and mixing information as necessary, and passing the merged information as a request to Acquirer Processor 1712. For example, the merged request may have as the values for its cost and quantity fields the sums of its constituent requests' cost and quantity fields, respectively. Some embodiments of the present technology may generate a list of combinations of transactions (aggregated or otherwise) that qualify for LT and select in step 1708 the combination that yields the lowest total interchange rate, or, in other embodiments, the highest rebate.

If, in step 1706, system 1606 does not find it beneficial (regardless of specific criteria) to aggregate payments, then in step 1710, system 1606 may pass on to Acquirer Processor 1712 the received requests unaltered. In some embodiments, the system may perform processing on the request data such as that depicted in FIG. 16 if data in the requests needs to be added, subtracted, or modified. Similarly in step 1702, if the system determines that the requests are not destined for the same payee on the same date, the system may go to step 1710.

FIG. 18 is a diagram showing one embodiment of the process 1800 by which the system may decide to disaggregate payments and transmit disaggregated payments to the Acquirer Processor. This disaggregation may occur when the system is attempting to decide whether or not to process payments at LT, such as at step 724 of FIG. 7 (general), step 1233 of FIG. 12 (LR), step 1333 of FIG. 13 (HR), step 1333 of FIG. 14 (BRLR), and step 1512 of FIG. 15 (LCR). Additionally, the flow chart consisting of steps 1802-1810, enclosed by the dotted-lined box, represents an exemplary decision-making process used by a system such as PDH 1606 to determine whether and how to disaggregate transactions. Payer 1801 may submit one or more transactions such as 1604 of FIG. 16 to a system such as PDH 1606. The system 1606 may then store these payments, possibly in a queue. In step 1802, system 1606 may determine whether it is storing payer-submitted transactions with a quantity greater than 1, or composed of multiple purchases in some other way. For example, the system may go to step 1802 if the payments are requested for HR rates, and an LT rate for an aggregate transaction would yield too low a rebate for the payer. If the transaction supplied by the payer is an aggregate of multiple transactions, then in step 1803, system 1606 uses its one or more processors to calculate the total rebate that would be earned if the transactions were processed individually. While in the diagram the system considers L3 rates, further embodiments of the system may consider rebates for other interchange rates, possibly using a process similar to that depicted in FIG. 14. In some embodiments of step 1803, the system may calculate such totals for each applicable credit card owned by the payer. In further embodiments, the processor/s may compute these rebates for some or all possible combinations of the transactions contained within the larger transaction submitted by payer 1801. In step 1804, the system may use its processor/s to compute the rebate that would be earned if the submitted payment were left as is. In further embodiments, the system may calculate this rebate for some or all of the credit cards owned by the payer 1801. Next, in step 1805, the system processor/s compare the rebate value computed in step 1804 with that obtained in step 1803. Some embodiments may perform this comparison per credit card owned by the payer. In step 1806, the system may decide on the basis of the comparison made in step 1805 whether or not, for at least one of the credit cards owned by the payer, disaggregating the transactions in some way yields a higher rebate. For steps 1803-1806, some embodiments may choose other criteria to compare the transactions. For instance, for an LR request, the comparison may be done based on whether the disaggregation does or does not yield a lower interchange rate, rather than a higher rebate. If the system has decided to disaggregate received payment requests, then the system may go to step 1808, in which it disaggregates the payments, changing and mixing information as necessary, and passing the split information as a request to Acquirer Processor 1812. For example, the input request may have as the values for its cost and quantity fields the sums of its output requests' cost and quantity fields, respectively. The depiction of two output requests is purely illustrative, and there may be more output requests depending on the conditions of the payment request data and the specific decision process of system 1606. Some embodiments of the present technology may generate a list of combinations of transactions (aggregated or otherwise) that qualify for LT and select in step 1808 the combination that yields the highest total rebate, or, in other embodiments, the lowest interchange rate.

If, in step 1806, system 1606 does not find it beneficial (regardless of specific criteria) to disaggregate payments, then in step 1810, system 1606 may pass on to Acquirer Processor 1612 the received requests unaltered. In some embodiments, the system may perform processing on the requests such as that depicted in FIG. 16 if data in the requests needs to be added, subtracted, or modified. Similarly in step 1802, if the system determines that the requests are not composed of enough items or requests to even enable splitting, the system may go to step 1810.

FIG. 19 depicts an exemplary process by which the system may select a credit card for a payment, given payment data and an interchange rate. The system may initiate the process depicted in FIG. 19 upon reaching steps 1407 (L1), 1420 (L2), 1430 (L3), 1440 (LT) in FIG. 14, wherein, for BRLR, the system has decided on an interchange rate and must further decide on a credit card at which to process the payment. While this example only shows two credit cards, A and B, embodiments of the presently disclosed technology may expand the process to compare any number of credit cards. Further embodiments may also apply this process to BINs instead of or in addition to credit cards.

The process depicted in FIG. 19 begins with step 1902, wherein the system is already given payment data and an interchange rate. The system may employ processor/s to compute rebates for cards A and B for the given interchange rate and compare them. If card A would yield a higher rebate, the system transitions to step 1904, in which the system generates a payment request using the provided data, the chosen interchange rate, and the credit card information pertaining to card A, in order to garner the higher rebate for the payer. Otherwise, the system transitions to step 1906, in which the system generates a payment request using the provided data, the chosen interchange rate, and the credit card information pertaining to card B, in order to garner the higher rebate for the payer. In other embodiments, step 1902 may compare cards A and B (or however many more there are) based on interchange rates instead of rebates, and may select the card (or BIN) based on whichever card yields the lowest interchange rate. Such embodiments may be useful in steps 1520 and 1530 of FIG. 15, wherein, pursuant to an LCR request, the system seeks to route the payment at the lowest possible interchange rate for the payee.

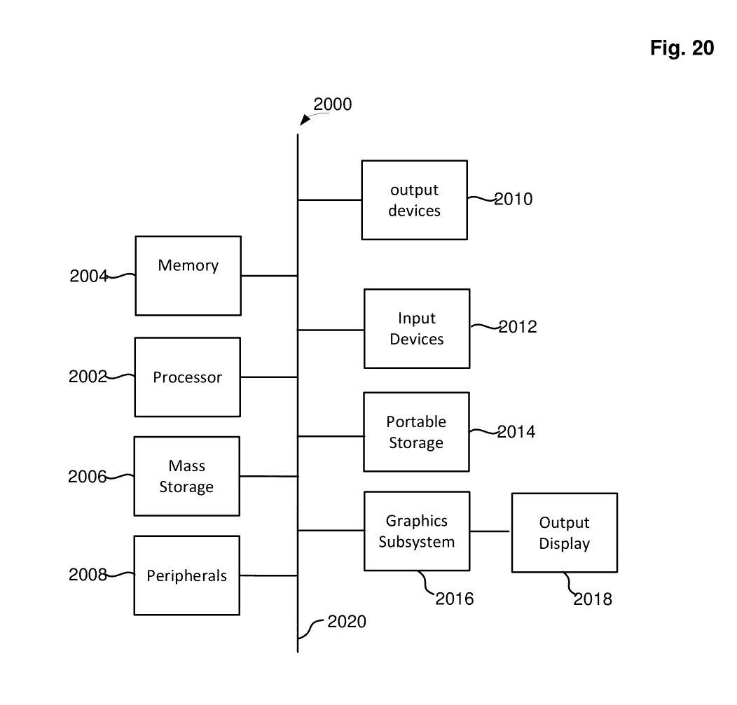

FIG. 20 shows an exemplary general structure 2000 of a computing system capable of performing some or all of the methods described herein. By way of example only, some or all the components and connections depicted in FIG. 20 may form part or all of the hardware architecture for a system 1606, which may be the PDH from FIGS. 1,3, and 4. Furthermore, the user terminal by which the payer may enter payment request data and receive notifications from the PDH may be similar in composition and function to the computing system of FIG. 20. The computing system of FIG. 20 includes one or more processors 2002 and main memory 2004. Main memory 2004 stores, in part, requests and data for execution by processor unit 2002. If the system of the present technology is wholly or partially implemented in software, main memory 2004 can store the executable code when in operation. Processor/s 2002, in cooperation with memory 2004, may perform various computational tasks material to the disclosed technology. For instance, the system may employ processor/s 2002 to perform the mathematical and logical operations required to evaluate the various aggregation and disaggregation options for payments as described for steps 1703-1706 and steps 1803-1806 of FIGS. 17 and 18, respectively. Processor/s 2002 may also be used to select interchange rates when given payer inputs such as LR, HR, BRLR, and LCR, employing processes such as those depicted in FIGS. 12-15. Processor/s 2002 may be used for many other additional purposes with respect to the present technology. Modern technology enables processor/s 2002 to respond to request data in real time—that is, almost immediately after receiving this data.

The system of FIG. 20 further includes a mass storage device 2006, peripheral device(s) 2008, user input device(s) 2012, output devices 2010, portable storage medium drive(s) 2014, a graphics subsystem 2016 and an output display 2018. For purposes of simplicity, the components shown in FIG. 20 are depicted as being connected via a single bus 2020. However, the components may be connected through one or more data transport means. For example, processor unit 2002 and main memory 2004 may be connected via a local microprocessor bus, and the mass storage device 2006, peripheral device(s) 2008, portable storage medium drive(s) 2014, and graphics subsystem 2016 may be connected via one or more input/output (I/O) buses. Mass storage device 2006, which may be implemented with a magnetic disk drive or an optical disk drive, is a non-volatile storage device for storing data and instructions for use by processor unit 2002. In one embodiment, mass storage device 2006 stores the system software for implementing the present technology for purposes of loading to main memory 2004. Storage 2006 may also retain part or all of the information regarding past payment transactions for a given payer or payee. In one embodiment, storage device 2006 is a processor readable storage device that stores code to program the processing unit to perform any of the method described herein.

Portable storage medium drive 2014 operates in conjunction with a portable non-volatile storage medium, such as a floppy disk, to input and output data and code to and from the system of FIG. 20. In one embodiment, the system software for implementing the present invention is stored on such a portable medium, and is input to the computer system via the portable storage medium drive 2014. Peripheral device(s) 2008 may include any type of computer support device, such as an input/output (I/O) interface, to add additional functionality to the computer system. For example, peripheral device(s) 2008 may include a network interface for connecting the computer system to a network, a modem, a router, etc. The communication interface by which system 1606 sends messages to (as depicted in FIGS. 17 and 18) and receives messages from the AP may at least in part comprise the networking devices as included in peripherals 2008.

User input device(s) 2012 provides a portion of a user interface. User input device(s) 2012 may include an alpha-numeric keypad for inputting alpha-numeric and other information, or a pointing device, such as a mouse, a trackball, stylus, or cursor direction keys. In the present technology, the payer may employ input devices 2012 to enter payment request data into the system. In order to display textual and graphical information, the system of FIG. 20 includes graphics subsystem 2016 and output display 2018. Output display 2018 may include a cathode ray tube (CRT) display, liquid crystal display (LCD) or other suitable display device. For instance, display 2018 may be used to show the payer a data entry form such as that depicted in FIG. 2 or FIG. 5, or payment authorization. Graphics subsystem 2016 receives textual and graphical information, and processes the information for output to display 2018. Additionally, the system of FIG. 20 includes output devices 2010. Examples of suitable output devices include speakers, printers, network interfaces, monitors, etc.

The components contained in the computing system of FIG. 20 are those typically found in systems suitable for use with the present technology, and are intended to represent a broad category of such components that are well known in the art. Thus, the system of FIG. 20 can be a personal computer, mobile computing device, workstation, server, minicomputer, mainframe computer, or any other computing device. In embodiments for which the physical system comprises a network of multiple computers, the system, by way of example only, may be composed of multiple repeating units 2000 linked together via various communicative mechanisms. The system can also include different bus configurations, networked platforms, multi-processor platforms, etc. Various operating systems can be used including Unix, Linux, Windows, Macintosh OS, Palm OS, and other suitable operating systems.

The foregoing description applies to a method for receiving payment request information from a payer of a terminal connected to a central computing system, the central computing system using data provided by the payer with the payment request information to determine an interchange rate and credit card information appropriate for the intended payment, and routing this payment at this rate and with this card to an Acquirer Processor or similar party, and the payment transaction being completed accordingly. The payer may specify a desired interchange rate, which the central computing system selects if suitable, or the payer may specify other criteria by which the central computing system may determine the interchange rate at which the payment will be routed. The central computing system is also able to fabricate and add any preferred line item information to the purchase data provided by the payer in the payment request in order to obtain a selected interchange rate. Further embodiments of the technology allow the central computing system to aggregate multiple payment requests designated for the same payee on the same date into a single request or disaggregate single requests into multiple payment requests if doing so yields more favorable interchange rates (or in some cases, rebates) for the payment transactions corresponding to these requests. Embodiments of the present technology may also have a means to learn whether or not a payment submitted to the Acquiring Processor has been authorized, as well as a means to communicate this information to the payer.

While the above method decides upon interchange rate and credit card for a payment from payer-specified choices, alternative methods described above may automatically decide which interchange rate and credit card to use based on other payment request data. The computing system may use real-time analysis to compare interchange rates and rebates for received payment requests and possible aggregations and/or disaggregations of payment requests.

Also described above is a basic system (2000) capable of executing the aforementioned methods, where the system may comprise, but need not be limited to, a communication interface, one or more processors, and a storage element. The communication interface is the means by which the system can send and receive messages, including payment data, to and from the payer and the Acquiring Processor. The one or more processors possess the capability to manipulate data and make decisions, including how to choose interchange rates based on payment data and how to aggregate or disaggregate payment requests. The storage element allows the system to retain information pertaining to past transactions as well as any other information helpful in allowing the whole system to function effectively.

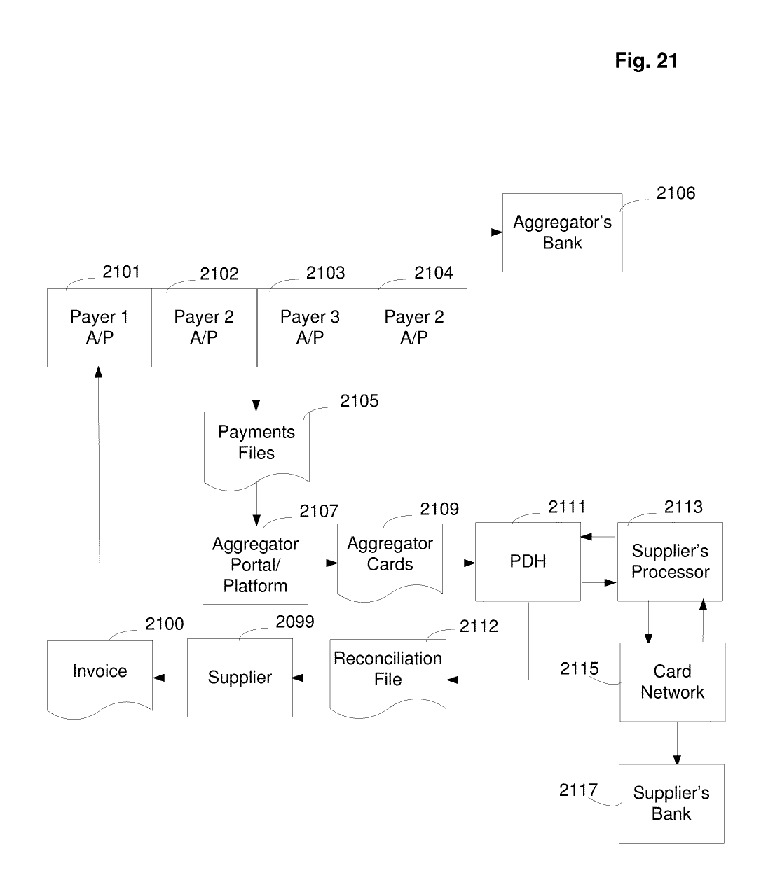

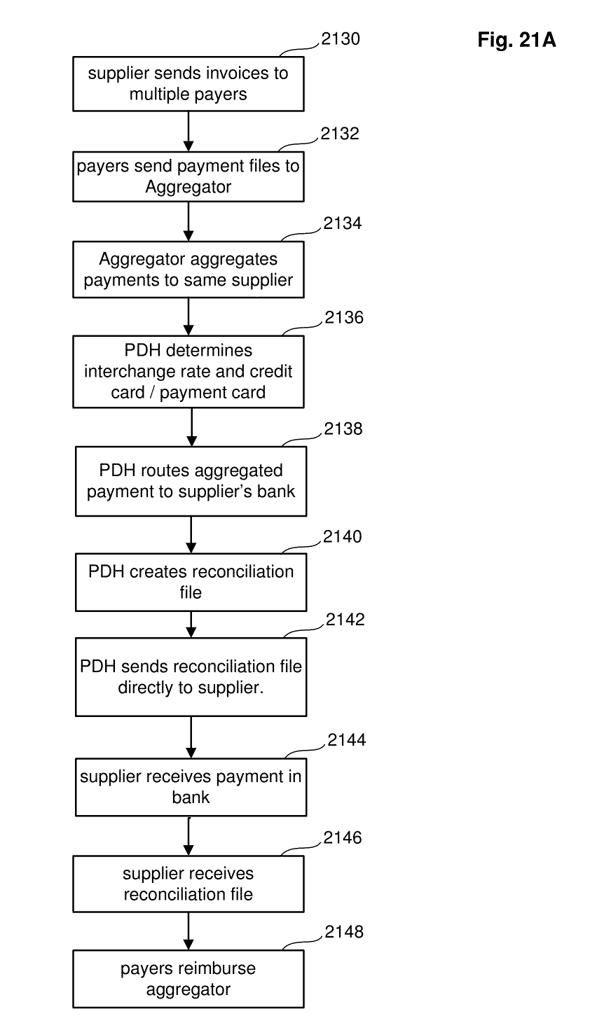

FIG. 21 illustrates a process by which the system may aggregate payments from multiple payers into a single payment intended for the same payee. In some embodiments, such a method may be employed by payers who have selected the LCR option, as described in FIG. 15, for routing their payments to a common payee or supplier. In other embodiments, the aggregation can be performed no matter what he payer selected for payment option. By so receiving aggregated payments, payees may stand to access lower interchange rates like LT because of the potentially large amounts of money being paid in the aggregate payments, and the payees (suppliers) may thus save significantly on interchange fees. The payers may or may not coordinate their payments to be aggregated. Some embodiments may require the payments to be not only directed towards the same supplier, but also have the same payment date, whereas other embodiments may queue payments, aggregating together and routing all queued payments for a given payee/supplier periodically, or upon direction by the supplier.

The process of FIG. 21 is further explained by the flow chart of FIG. 21A. Supplier 2099 will send an invoice (or multiple invoices) 2100 of payments to be made to multiple payers, such as to payers 1-4 (objects 2101-2104) in step 2130. The invoice contain basic information such as the items exchanged and the money owed. The use of four payers in this scenario is purely exemplary, and any number of payers can use this method in embodiments. In response to invoice(s) 2100, the payers send multiple payment files 2105, using any of the methods known in the art to transport payment files 2105, to an entity called an “aggregator portal” or “aggregator platform” 2107, which will interact with the PDH 2111 on behalf of the payers, in step 2132. The institution that fulfills the role of the aggregator portal/platform may also be known as a “payment aggregator,” a “payment processor,” or “supply chain financier.” The aggregator is separate from the supplier. In some embodiments, the aggregator operates the PDH (discussed above). The payment files 2105 can be in any suitable form, including the structures discussed above. The payment files 2105 each represent payment requests. As discussed above, some payment requests will identify an interchange, and some will not.

In step 2134, the Aggregator 2107 will aggregate payments from multiple payers that are for paying a common supplier (e.g., supplier 2099) to create a single aggregated payment request. Aggregator 2107 is in communication with and/or working with PDH 2111. In some embodiments, PDH 2111 aggregates the payments. In step 2136, PDH 2111 determines an interchange rate and credit card (or payment card), as per any of the processes discussed above. In one embodiment, there will be multiple cards and interchanges to choose from. Additionally, fabricated data can be added to the aggregated payment request (as discussed above) to obtain a better interchange rate. Aggregating the payments may allow for a lower interchange rate. In some embodiments, the interchange rate chosen for the aggregated payment request will be lower than an interchange rate that at least one of the payment requests would qualify for if not aggregated. In some embodiments, the interchange rate chosen for the aggregated payment request will be lower (or at least different) than an interchange rate identified in at least a subset of the payment requests received from the different payers. In some embodiments, Aggregator 2107 determines the interchange rate and card.

In step 2138, PDH 2111 (or equivalent system or Aggregator 2107) communicates a payment request, using the chosen card and interchange rate, to the Acquiring Processor 2113 of the supplier 2099, who is common to the payments contained in files 2105. The PDH may have constructed the payment request from payments 2105 using the aggregation process 1700, as discussed in FIG. 17, aggregating the line items and adding the monetary amounts as is proper.

In step 2140, the PDH 2111 creates a reconciliation file/report to send to the supplier that indicates which payers and invoices are included in the aggregated payment. The reconciliation file can be in any suitable form or structure, such as EDI 820. In one embodiment, the Aggregator creates and sends the reconciliation report. In one embodiment, the bank or banks issue the Aggregator the payment/credit card(s) to the Aggregator 2107, and the Aggregator 2107 carries the credit facility (not the payer as in the traditional model). At some point in time, however, the payers will pay whatever amount of money is owed to the supplier 2099 to the aggregator's account in bank 2106, thereby compensating the payment processor for handling the supplier payment as an intermediary. This reimbursement may take many forms, such as a physical check, Automated Clearing House (ACH), wire, online card payment, etc.

In step 2142, PDH 2111 electronically sends the reconciliation file 2112 directly to the supplier 2099 (e.g., via email, HTTP or other method). The suppliers bank 2117 (via the supplier's processor 2113 and the card network 2115) will receive the aggregated payment in step 2144. The supplier's processor 2113 settles the payment with the card network 2115. Assuming there are no problems with the purchase cards 2109 of portal/platform 2107, credit card network 2115 makes the necessary deposit into the supplier's designated account in bank 2117, thus completing the payment transaction for which invoice 2100 was originally sent. Network 2115 reports this successful deposit to the supplier's acquiring processor, which relays the information concerning this successful payment to PDH 2111. The supplier 2099 will receive the reconciliation file 2112 in step 2146. In step 2148, the payers reimburse the Aggregator for the payments, as discussed above.

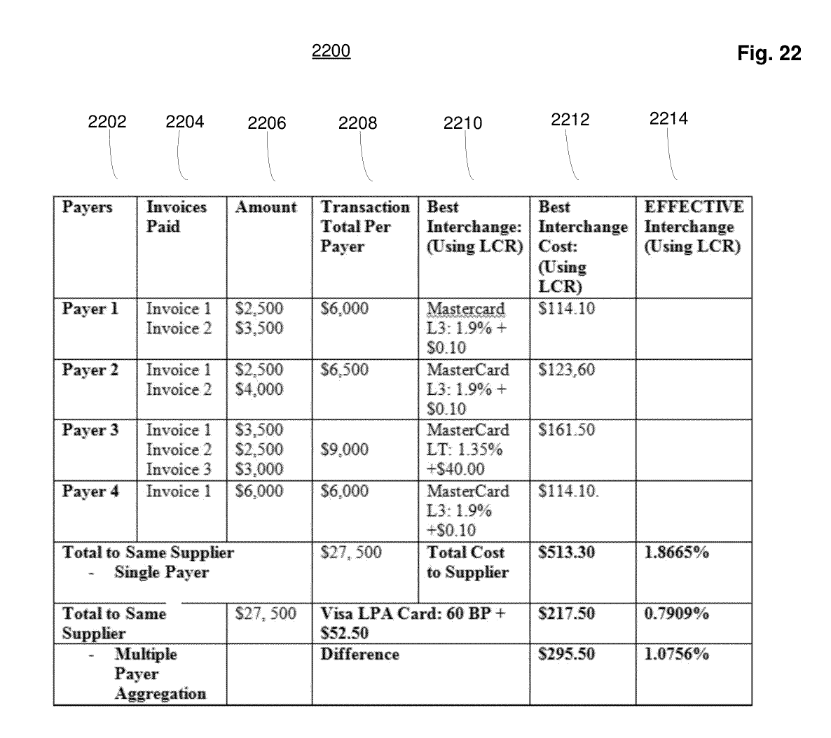

FIG. 22 is a table with exemplary data that shows the benefit of aggregating the payments. Column 2202 lists four payers (1-4), representing payers 2101-2104 in FIG. 21, though embodiments of the present technology need not be limited to a specific number of payers. Column 2204 shows the invoices being paid. Column 2206 indicates amount of each invoice. Column 2208 shows the transaction interchange used if the payments are not aggregated across all payers (the invoices are aggregated within each payer). Column 2208 shows the transaction interchange rate used if the payments are not aggregated across all payers. Column 2214 shows that if there is no aggregation across all payers, then the effective interchange rate for the four payers is 1.8665%. If the payments are aggregated across all payers, the aggregated transaction is eligible for a better interchange (Visa LPA Card: 60 BP+$52.50), resulting in an interchange rate of 0.7909%. Thus, aggregating the payment reduces the effective interchange rate by 1.0756%.

One embodiment comprises electronically receiving payment request information at a hub computing system (the payment request information includes an identification of a supplier, one or more transactions and an interchange request); if the interchange request identifies a specific interchange rate, automatically generating a payment request for the one or more transactions at the specific interchange rate; if the interchange request includes an indication to choose an interchange rate, automatically choosing an interchange rate previously used by the hub computing system for paying the supplier that has been accepted by the supplier and is not the lowest possible interchange rate, and automatically generating the payment request for the one or more transactions at the chosen interchange rate; electronically transmitting the payment request from the hub computing system to an acquirer processor computing system associated with the supplier; receiving an authorization notification at the hub computing system with respect to the payment request; and reporting the authorization.

One embodiment comprises a storage device, a communication interface and one or more processor in communication with the storage device and the communication interface. The one or more processors electronically receive payment request information via the communication interface. The payment request information includes an identification of a supplier and an interchange request. If the interchange request identifies a specific interchange rate, then the one or more processors generate a payment request at the specific interchange rate. If the interchange request includes an indication to choose an interchange rate, then the one or more processors choose an interchange rate previously successfully used by the one or more processors for paying the supplier that is not the lowest possible interchange rate and generate the payment request at the chosen interchange rate. The one or more processors transmit the payment request to an acquirer processor computing system associated with the supplier and receive a notification in response to the payment request. The one or more processor reports the response.

One embodiment includes electronically receiving payment request information at a hub computing system. The payment request is to pay a supplier on behalf of a payer. The process further includes automatically choosing a lowest interchange rate, that is not the lowest possible interchange rate, which has been successfully used by the hub computing system for the supplier and any payer; automatically generating a payment request at the chosen interchange rate; electronically transmitting the payment request from the hub computing system to an acquirer processor computing system associated with the supplier; receiving an authorization notification at the hub computing system with respect to the payment request; and reporting the authorization.

One embodiment comprises electronically receiving payment request information at a hub computing system, the payment request information includes an identification of a supplier, one or more transactions, one or more payment amounts and an interchange request, the interchange request includes an indication to choose an interchange rate; automatically analyzing the payment request information in real time; automatically determining a lowest cost interchange rate between multiple card BINs based on the analyzing the payment request in real time; automatically generating a payment request for the one or more transactions at the chosen interchange rate and card BIN; electronically transmitting the payment request from the hub computing system to a computing system associated with the supplier; receiving an authorization notification at the hub computing system with respect to the payment request; and reporting the authorization.

One embodiment includes electronically receiving payment requests at an from multiple payers for a common supplier, the payments are received ay an entity that is separate from the common supplier and the multiple payees; aggregating the payment requests and creating a single aggregated payment request at a hub computing system, the aggregating and creating includes choosing an interchange rate at the aggregator for the aggregated payment that is lower than an interchange rate that at least one of the payment requests would qualify for if not aggregated; electronically transmitting the aggregated payment request from the hub computing system to an acquirer processor computing system associated with the supplier; creating a reconciliation report; and transmitting the reconciliation report to the supplier.

One embodiment includes an apparatus for processing payment requests, comprising a storage device; a communication interface; and one or more processor in communication with the storage device and the communication interface. The one or more processors receive payment requests from multiple payers for a common supplier. The one or more processors aggregate the payment requests and create a single aggregated payment request at a hub computing system. The aggregating and creating includes choosing an interchange rate for the aggregated payment that is lower than an interchange rate that at least one of the payment requests would qualify for if not aggregated. The one or more processors transmit the aggregated payment request to an acquirer processor computing system associated with the supplier. The one or more processors create a reconciliation report and transmit the reconciliation report to the supplier.

One embodiment includes one or more processor readable storage devices storing processor readable code for programming a processor to perform a method comprising: electronically receiving payment requests from multiple payers for a common supplier; aggregating the payment requests and creating a single aggregated payment request, the aggregating and creating includes choosing an interchange rate for the aggregated payment that is lower than an interchange rate that at least one of the payment requests would qualify for if not aggregated; electronically transmitting the aggregated payment request to an acquirer processor computing system associated with the supplier; creating a reconciliation report; and transmitting the reconciliation report to the supplier.

The foregoing detailed description has been presented for purposes of illustration and description. It is not intended to be exhaustive or limiting to the precise form disclosed. Many modifications and variations are possible in light of the above teaching. The described embodiments were chosen in order to best explain the principles of the disclosed technology and its practical application, to thereby enable others skilled in the art to best utilize the technology in various embodiments and with various modifications as are suited to the particular use contemplated. It is intended that the scope be defined by the claims appended hereto.

I claim:

1. A method for processing payment requests, comprising:
electronically receiving payment request information at a hub computing system, the payment request information includes an identification of a supplier, one or more transactions and an interchange request;
if the interchange request identifies a specific interchange rate, automatically generating a payment request for the one or more transactions at the specific interchange rate;
if the interchange request includes an indication to choose an interchange rate, automatically choosing an interchange rate previously used by the hub computing system for paying the supplier that has been accepted by the supplier and is not the lowest possible interchange rate, and automatically generating the payment request for the one or more transactions at the chosen interchange rate;
electronically transmitting the payment request from the hub computing system to an acquirer processor computing system associated with the supplier;
receiving an authorization notification at the hub computing system with respect to the payment request; and
reporting the authorization.

2. The method for processing of claim 1, wherein the automatically generating the payment request for the one or more transactions at the specific interchange rate comprises:
generating the payment request at an L1 interchange rate if the interchange request identifies a L1 interchange rate;
generating the payment request at an L2 interchange rate if the interchange request identifies a L2 interchange rate; and
generating the payment request at an L3 interchange rate if the interchange request identifies a L3 interchange rate.

3. The method for processing of claim 2, wherein the automatically choosing an interchange rate comprises:
choosing a lowest interchange rate successfully used by the hub computing system for paying the supplier for any payer.

4. The method for processing of claim 1, wherein the automatically choosing an interchange rate comprises:
choosing a lowest interchange rate successfully used by the hub computing system for paying the supplier for any payer.

5. The method for processing of claim 1, wherein the automatically choosing an interchange rate comprises:
choosing a highest interchange rate successfully used by the hub computing system for paying the supplier for any payer.

6. The method for processing of claim 1, wherein the automatically choosing an interchange rate comprises:
choosing a interchange rate, of interchange rates successfully used by the hub computing system for paying the supplier for any payer, that results in a highest rebate to a payer for the one or more transactions.

7. The method for processing of claim 1, wherein the automatically choosing an interchange rate comprises:
disaggregating transactions; and
choosing an interchange rate, of interchange rates successfully used by the hub computing system for paying the supplier for any payer, for the disaggregated transactions that results in highest rebates to a payer for the one or more transactions.

8. The method for processing of claim 1, wherein the generating the payment request for the one or more transactions at the chosen interchange rate comprises:
choosing a payment card with a highest rebate to a payer for the one or more transactions for the chosen interchange rate; and
generating the payment request for the one or more transactions at the chosen interchange rate for the chosen payment card.

9. The method for processing of claim 1, wherein:
the automatically choosing an interchange rate comprises choosing a lowest interchange rate successfully used by the hub computing system for paying the supplier for any payer; and
the generating the payment request for the one or more transactions at the chosen interchange rate comprises choosing a payment card with a highest rebate to a payer for the one or more transactions for the chosen interchange rate and generating the payment request for the one or more transactions at the chosen interchange rate for the chosen payment card.

10. The method for processing of claim 1, wherein the generating the payment request for the one or more transactions at the chosen interchange rate comprises:
adding fabricated data to the payment request to obtain a better interchange rate, the fabricated data is not received with the payment request information, the fabricated data is added by the hub computing system.

11. The method for processing of claim 10, wherein:
the fabricated data includes tax information.

12. The method for processing of claim 10, wherein:
the fabricated data includes information about sale of an item.

13. The method for processing of claim 1, wherein the generating the payment request for the one or more transactions at the chosen interchange rate comprises:
aggregating multiple transactions into one larger transaction to obtain a lower interchange rate.

14. The method for processing of claim 1, wherein the generating the payment request for the one or more transactions at the chosen interchange rate comprises:
choosing whether to aggregate multiple transactions into one larger transaction to obtain a lower interchange rate based on determining which interchange rate will result in a higher rebate to a payee.

15. The method for processing of claim 1, wherein:
the reporting the authorization includes reporting electronically in real time for display in a graphical user interface.

16. An apparatus for processing payment requests, comprising:
a storage device;
a communication interface; and
one or more processor in communication with the storage device and the communication interface, the one or more processors electronically receive payment request information via the communication interface, the payment request information includes an identification of a supplier and an interchange request, if the interchange request identifies a specific interchange rate then the one or more processors generate a payment request at the specific interchange rate, if the interchange request includes an indication to choose an interchange rate then the one or more processors choose an interchange rate previously successfully used by the one or more processors for paying the supplier that is not the lowest possible interchange rate and generate the payment request at the chosen interchange rate, the one or more processors transmit the payment request to an acquirer processor computing system associated with the supplier and receive a notification in response to the payment request, the one or more processor reports the response.

17. The apparatus of claim 16, wherein:
the one or more processors choose the interchange rate by choosing a lowest interchange rate successfully used by the one or more processors for paying the supplier for any payer.

18. The apparatus of claim 16, wherein:
the one or more processors choose the interchange rate by choosing a highest interchange rate successfully used by the one or more processors for paying the supplier for any payer.

19. The apparatus of claim 16, wherein:
the one or more processors choose the interchange rate by choosing a interchange rate, of interchange rates successfully used by one or more processors for paying the supplier for any payer, that results in a highest rebate to a payer for the payment request.

20. The apparatus of claim 16, wherein:
the one or more processors choose the interchange rate by choosing a lowest interchange rate successfully used by the one or more processors for paying the supplier for any payer; and
the one or more processors generate the payment request at the chosen interchange rate by choosing a payment card with a highest rebate to a payer associated with the payment request for the chosen interchange rate and generating the payment request at the chosen interchange rate for the chosen payment card.

21. A method for processing payment requests, comprising:
electronically receiving payment request information at a hub computing system, the payment request is to pay a supplier on behalf of a payer;
automatically choosing a lowest interchange rate, that is not the lowest possible interchange rate, which has been successfully used by the hub computing system for the supplier and any payer;
automatically generating a payment request at the chosen interchange rate;
electronically transmitting the payment request from the hub computing system to an acquirer processor computing system associated with the supplier;
receiving an authorization notification at the hub computing system with respect to the payment request; and
reporting the authorization.

22. The method for processing of claim 21, wherein:
the generating the payment request comprises the hub computing system choosing a payment card with a highest rebate to the payer and generating the payment at the chosen interchange rate for the chosen payment card.

23. A method for processing payment requests, comprising:
electronically receiving payment request information at a hub computing system, the payment request information includes an identification of a supplier, one or more transactions, one or more payment amounts and an interchange request, the interchange request includes an indication to choose an interchange rate;
automatically analyzing the payment request information in real time;
automatically determining a lowest cost interchange rate between multiple card BINs based on the analyzing the payment request in real time;
automatically generating a payment request for the one or more transactions at the chosen interchange rate and card BIN;
electronically transmitting the payment request from the hub computing system to a computing system associated with the supplier;
receiving an authorization notification at the hub computing system with respect to the payment request; and
reporting the authorization.

24. The method for processing of claim 23, wherein:
the automatically determining a lowest cost interchange rate includes identifying a first interchange rate for a first card based on amount, identifying a second interchange rate for a second card based on amount, and determining which of the first interchange rate and second interchange rate is lower.

25. The method for processing of claim 23, wherein:
the automatically determining a lowest cost interchange rate includes identifying interchange rates for a first card based on amounts of one or more aggregations of the one or more transactions, identifying interchange rates for a second card based on amounts of one or more aggregations of the one or more transactions, and determining which of the identified interchange rates is lowest.
